(19) United States
(12) Patent Application Publication
(10) Pub. No.: US 2025/0297080 A1
(43) Pub. Date: Sep. 25, 2025

(54) HYALOCLASTITE MINERAL RUBBER FILLER, HYALOCLASTITE RUBBER COMPOSITIONS AND PRODUCTS, AND METHOD OF MAKING AND USING SAME

(71) Applicant: Greencraft LLC, Norcross, GA (US)

(72) Inventor: Romeo Ilarian Ciuperca, Atlanta, GA (US)

(73) Assignee: Greencraft LLC, Norcross, GA (US)

(21) Appl. No.: 18/612,108

(22) Filed: Mar. 21, 2024

(51) Int. Cl. C08K 3/40; B60C 1/00

(52) U.S. Cl. CPC C08K 3/40; B60C 1/00; C08K 2201/005

(57) ABSTRACT

The invention comprises a composition. The composition comprises an uncured rubber material blended with hyaloclastite having a volume-based mean particle size of less than or equal to 160 μm. A process for making the composition is also disclosed.

### CROSS-REFERENCE TO RELATED APPLICATIONS

This application claims the benefit of application Ser. No. 63/491,883 filed Mar. 23, 2023.

### FIELD OF THE INVENTION

The present invention relates generally to an additive for rubber materials and compositions. More specifically, the present invention relates to a natural mineral that can be used as an additive to modify the physical properties of rubber materials and compositions. The present invention also relates to a natural material that can be used as a filler for rubber materials and compositions. The additive of the present invention can also be used with both natural rubber materials and synthetic rubber materials.

### BACKGROUND OF THE INVENTION

Natural rubber, also known as latex or gum rubber, is a flexible and elastic material that is derived from the milky sap or latex of the rubber tree (Hevea brasiliensis). It is made up of solid particles suspended in a milky white liquid (called latex) that drips from the bark of certain tropical and subtropical trees. Synthetic rubber is an artificial elastomer, which means it's a type of polymer that exhibits elastic properties. These polymers are synthesized from petroleum byproducts.

There is great interest in the development of fillers for natural rubber and synthetic rubber materials that do not emit toxic compounds during thermal decomposition and that improve physical properties, thermal stability, flame spread and fire resistance properties of natural rubber and polymeric rubber materials.

The primary fillers used for the production of rubber articles are black, such as carbon black, and non-black fillers. The non-black fillers for rubber are typically calcium carbonate, kaolin clay, precipitated silica, talc, barite, wollastonite, mica, precipitated silicates, fumed silica and diatomite. Of these, the three most widely used, by volume and by functionality, are calcium carbonate, kaolin clay and precipitated silica. Different rubber compounds exist for various applications, each with a specific combination of materials to provide desired performance attributes for specific applications.

A polymeric rubber compound contains, on average, less than 5 lbs. of chemical additives per 100 lbs. of elastomer, while filler loading is typically 10-15 times higher. Of the ingredients used to modify the properties of rubber products, fillers often play a significant role. Most of the rubber fillers used today offer some functional benefit that contributes to the processability or utility of the rubber product. Styrene butadiene rubber, for example, has virtually no commercial use as an unfilled compound. Based on the effect they have on the rubber, fillers are reinforcing, such as precipitated silica, semi-reinforcing, such as kaolin and non-reinforcing, such as calcium carbonate.

Carbon black, defined by a specific CAS number, is produced by incomplete combustion of oil or coal under specific conditions and has a long history of use. Approximately 65% of the world's 8 million tons per year of carbon black are used in tire production. Several parameters are controlled in the process in order to achieve the specific characteristics of the finished carbon black products. Carbon black has hydrophobic properties and therefore is chemically compatible with the rubber and polymer chemistry allowing for good chemical bonds between the rubber or polymer and the carbon black filler. However, carbon black is a toxic compound and it would be desirable to find a substitute, in whole or part, that would have similar performance as a filler for use in natural rubber or polymeric rubber formulations and products.

Amorphous precipitated silica is produced from vitreous silicate. The vitreous silicate is dissolved in water and transferred to a reactor in which, through acidification and agitation, amorphous silica is precipitated out. During this precipitation there is an instantaneous formation of primary nanoscale particles (from approximately 2 to 40 nm) of a very short lifespan and they immediately cluster to form non-dissociable aggregates (from approximately 100 to 500 nm in size) based on covalent bonds. The aggregates subsequently electrostatically bind together to form agglomerates from 1 to 40 μm. At the end of the precipitation process, after drying and washing, the precipitated amorphous silica is mechanically processed into micro pearls or granules (dimension of 1/10 mm to a few mm) to ease shipping, handling and use. It is this form that is used by the tire industry among others. During rubber compounding, due to the high energy involved, the granules or micropearls of the precipitated silica are broken down, transforming back to the aforementioned agglomerates with dimensions between 1 and 40 microns. Because of the strong mechanical energy applied to the rubber, agglomerates may be broken down and transformed into aggregates, some of which are of nanometric size (their dimension ranges between 100 to 500 nanometers). Yet, the particle shape on the precipitated silica is either a single spherical or a multiple of agglomerated spheres therefore these aggregates are chemically bound to the rubber matrix by strong chemical links that result from the manufacturing process and very little physical penetration of the body of the precipitated silica filler aggregate particle. Spherical particles contain the least amount of surface area having mostly convex, round surfaces with a low aspect ratio. However precipitated silica is a good reinforcing filler in rubber due to the size of the particles meaning that the precipitated silica overcomes the spherical shape drawback by being an extremely small size in the few microns to nanometers. Additionally, precipitated silica is acidic and chemically hydrophilic, therefore incompatible with the rubber chemistry. As such it requires treatment with silane, such as bifunctional organosilane, known as a coupling agent, to make it chemically hydrophobic and therefore compatible with hydrocarbon rubbers and polymers, and increase its effectiveness as a rubber reinforcement filler. Precipitated silica is usually sold with about 6% adsorbed free water and a surface essentially saturated with silanol groups. Water content of the precipitated silica can inhibit the reaction of accelerators and the rubber matrix bonding to the silica particle. Producing low moisture precipitated silica, however, is generally impractical due to the high cost of drying the silica during manufacture and its natural tendency to absorb (or lose) moisture to maintain equilibrium with the relative humidity of its environment. It would be desirable to find a substitute with hydrophobic properties and with low moisture content to substitute for precipitated silica, in whole or part, that would have similar performance as a filler for use in natural rubber or polymeric rubber formulations and products.

Calcium carbonates for rubber, often referred to as “whiting”, fall into two general classifications. The first is wet or dry ground natural limestone, spanning average particle sizes of 5000 nm down to about 700 nm. The second is precipitated calcium carbonate (PCC) with fine and ultrafine products extending the average particle size range down to 40 nm. The ground natural products used in rubber are low aspect ratio, low surface area and low in surface activity. They are widely used, nevertheless, because of their low cost, and because they can be used at very high loadings with little loss of compound softness, elongation or resilience. This follows from the relatively poor polymer-filler adhesion potential, as does poor abrasion and tear resistance.

Kaolin clay is a platy aluminosilicate. Its continuous sheet structure produces thin particles which exist in nature as overlapping flakes. These can occur as “books” which under magnification resembling stacks of paper. Kaolin crystals are bound via hydrogen bonding of the octahedral layer hydroxyl face of one plate to the tetrahedral layer oxygen face of the adjacent plate. Separation into individual clay plates is therefore difficult, but can be accomplished by mechanical means to produce delaminated kaolin. Kaolin clays also have to be treated with silanes to improve chemical bonds with the rubber compounds.

The characteristics which determine the properties a filler will impart to a rubber compound are specific gravity, particle size, particle surface area, particle surface activity and particle shape. Surface activity relates to the compatibility of the filler with a specific elastomer and the ability of the elastomer to adhere to the filler. Lower specific gravity fillers will generally require higher amounts in a rubber compound while fillers with a higher specific gravity require less amount of filler for similar applications. In the fillers mentioned above, if the size of the filler particle greatly exceeds the polymer interchain distance, it introduces an area of localized stress. This can contribute to elastomer chain rupture on flexing or stretching. Fillers with particle size greater than 10,000 nm (10 m) are therefore generally avoided because they can reduce performance rather than extend or reinforce. Fillers with particle between 1,000 and 10,000 nm (1 to 10 km) are used primarily as diluents and usually have no significant effect, positive or negative, on rubber properties. Semi-reinforcing fillers range from 100 to 1000 nm (0.1 to 1 m). The truly reinforcing fillers, which range from 10 nm to 100 nm (0.01 to 1 km), can significantly improve rubber properties. In most cases, particle size is actually measured as equivalent spherical diameter rather than actual size or dimensions. For round or block-shaped particles, such as natural calcium carbonate, there is no significant difference. For platy minerals, such as clay, talc and mica, or needle-like minerals, such as wollastonite, the equivalent spherical diameter will inaccurately represent actual particle dimensions. For platy and needle shaped fillers, the particle aspect ratio may be at least as useful as particle “size”. For kaolin clay and other platy minerals, this is the ratio of the diameter of a circle with the same area as the face of the plate to the thickness of the plate. For needle and fiber-shaped fillers, the aspect ratio is the ratio of length to diameter. A filler must make intimate contact with the elastomer chains if it is going to contribute to reinforcement of the rubber-filler composite. Fillers that have a high surface area have more contact area available, and therefore have a higher potential to reinforce the rubber chains. The shape of the particle is also important. Particles with a planar shape have more surface available for contact with the rubber matrix than isotropic particles with an equivalent particle diameter. Among the calcium carbonates, for example, only the finest precipitated grades can expose a surface area equivalent to the surface area of hard clay. Isometric fillers that are approximately round, cubic or blocky in shape, are considered low aspect ratio. Low, in this context, means less than about 5:1 aspect ratio. Platy, acicular (needle-shaped) and fibrous fillers are considered high aspect ratio. Aspect ratio is not applied to carbon black and precipitated silica. The primary particles of these fillers are essentially spherical, but these spheres aggregate in such a way that the functional carbon black and precipitated silica filler “particles” are aggregated chains or bundles. The anisometry of these fillers is described in terms of “structure”, which incorporates aggregate shape, density and size. The higher the structure, the greater the reinforcement potential.

A filler can offer high surface area, high aspect ratio and small particle size, but still provide relatively poor reinforcement if it has low specific surface activity. In the simplest terms, this means the affinity for and ability to bond to the rubber matrix. Carbon black particles, for example, have carboxyl, lactone, quinone, and other organic functional groups which promote a high affinity of rubber to filler. This, together with the high surface area of the black, means that there will be intimate elastomer-black contact. The black also has a limited number of chemically active sites (less than 5% of total surface) which arise from broken carbon-carbon bonds because of the methods used to manufacture the black. The close contact of elastomer and carbon black will allow these active sites to chemically react with elastomer chains. The non-black fillers generally offer less affinity and less surface activity toward the common elastomers. Clay and silica surfaces are hydrophilic, but still react as acids and are capable of forming hydrogen bonds. The affinity and activity of non-black fillers in relation to elastomers can be improved by certain surface treatments. Regardless of filler size and shape, intimate contact between the matrix and mineral particles is essential, since air gaps represent points of permeability and zero strength. The surface chemistry of the filler will determine affinity for the matrix, or the ability of the rubber matrix to “wet” the filler surface. It is easier for most elastomers to “wet” the naturally hydrophobic carbon black surface, as compared to the naturally hydrophilic surfaces of most non-black fillers. This advantage of carbon black complements its reactivity. The hydrophobicity and the reactivity of most non-black fillers can be improved with suitable surface coatings. The conventional surface treatment for calcium carbonate is stearic acid, which improves the hydrophobicity and “wettability” of the filler, but does not provide for filler-matrix adhesion. Maleated polybutadiene (polybutadiene with grafted maleic anhydride functional groups) has been used as an in situ coupling agent to improve matrix adhesion to calcium carbonate fillers. Silica and silicate fillers have active surface silanols, ATH has active surface aluminols, kaolin has both organosilanes are fond of hydroxyls. The surface hydroxyls on most non-black fillers allow for particle treatment with hydrophobizing and/or coupling grades of organosilanes.

Increasing surface area (decreasing particle size) gives: higher Mooney viscosity, tensile strength, abrasion resistance, tear resistance, and hysteresis; lower resilience. Increasing surface activity (including surface treatment) gives: higher abrasion resistance, chemical adsorption or reaction, modulus, and hysteresis (except for silane-treated fillers). Increasing aspect ratio or structure gives: higher Mooney viscosity, modulus and hysteresis; lower resilience and extrusion shrinkage; longer incorporation time. The force required to stretch a defined specimen of rubber to a given percent elongation is measured as modulus. Most often, modulus is reported at 300% elongation (four times the original length). This can be alternatively viewed as the resistance to a given elongating force. For an uncompounded elastomer, elongation is primarily a function of stretching and disentangling the randomly oriented polymer chains and breaking the weak chain-chain attractions. Vulcanized, but unfilled, elastomers, for example, more strongly resist elongation because the sulfur crosslinks must be stretched and broken to allow chain extension and separation. Filler particle are considerably harder than the surrounding matrix and can thus insulate the rubber against wear. Filler size, shape and matrix adhesion therefore also affect abrasion resistance. Loss of large or poorly bound filler particles by abrasion exposes the relatively soft surrounding elastomer matrix to wear. The effect is acute on the edge of the depression left by the dislodged particle. This is the area most susceptible to elongation, crack initiation and ultimate loss.

It would be desirable to provide an additive or filler for rubber materials and compounds, both natural and synthetic, that can affect the physical, thermal stability, flame spread and fire resistance properties thereof.

### SUMMARY OF THE INVENTION

The present invention satisfies the foregoing needs by providing an improved natural mineral additive for rubber materials and compounds.

In one disclosed embodiment, the present invention comprises a product. The product comprises a rubber material combined with hyaloclastite having a volume-based mean particle size of less than or equal to 160 μm.

In another disclosed embodiment, the present invention comprises a product. The product comprises a rubber material combined with hyaloclastite having a volume-based mean particle size of less than or equal to 160 μm, wherein the hyaloclastite is basaltic hyaloclastite or intermediate basaltic hyaloclastite.

In another disclosed embodiment, the present invention comprises a process. The process comprises combining hyaloclastite with an uncured or unset rubber material to thereby form a uniform mixture thereof, wherein the hyaloclastite has a volume-based mean particle size of less than or equal to 160 μm.

In yet another disclosed embodiment, the present invention comprises a process. The process comprises combining hyaloclastite with a rubber material, wherein the hyaloclastite has a volume-based mean particle size of less than or equal to 160 μm and extruding the mixture.

In another disclosed embodiment, the present invention comprises a process. The process comprises combining hyaloclastite with an uncured or unset rubber material to thereby form a uniform mixture thereof, wherein the hyaloclastite has a volume-based mean particle size of less than or equal to 160 μm and curing or setting the rubber material.

In a further disclosed embodiment of the present invention, the invention comprises a process. The process comprises combining hyaloclastite with an uncured or unset rubber material to thereby form a uniform mixture thereof, wherein the hyaloclastite has a volume-based mean particle size of less than or equal to 160 μm and wherein the hyaloclastite is basaltic hyaloclastite or intermediate basaltic hyaloclastite.

Accordingly, it is an object of the present invention to provide an improved natural mineral additive for rubber materials.

Another object of the present invention is to provide an improved filler for rubber materials.

Another object of the present invention is to provide an improved natural mineral additive for rubber materials that can modify the physical properties thereof.

Another object of the present invention is to provide a natural mineral additive for rubber materials that improves the thermal stability properties thereof.

Another object of the present invention is to provide a natural mineral additive for rubber materials that improves the flame spread and fire resistance properties thereof.

Another object of the present invention is to provide a natural mineral additive or filler for rubber materials that is non-toxic.

These and other objects, features and advantages of the present invention will become apparent after a review of the following detailed description of the disclosed embodiments and the appended claims.

### BRIEF DESCRIPTION OF THE DRAWINGS

FIG. 1 is a flow diagram of a disclosed embodiment of a natural mineral processing plant in accordance with the present invention.

FIG. 2 is a flow diagram of another disclosed embodiment of a natural mineral processing plant in accordance with the present invention.

FIG. 3 is an illustration of how to determine the circle fit of an irregularly shaped particle.

FIG. 4 is an illustration of how to determine the circularity of an irregularly shaped particle.

### DETAILED DESCRIPTION OF THE DISCLOSED EMBODIMENTS

The present invention related to novel natural rubber and synthetic rubber compositions including hyaloclastite, or lava quenched by water, in powder form. The present invention also related to novel products made from novel natural rubber and synthetic rubber compositions including hyaloclastite, or lava quenched by water, in powder form.

Hyaloclastite, or lave quenched by water, of basaltic or intermediate basaltic chemistry, has high thermal stability with softening temperature of up to T=1200° C. It has been discovered in accordance with the present invention that when ground to a fine powder form hyaloclastite can be used as a filler which strengthens and reduces the heat built-up, flammability and scorch risk of natural rubber and polymeric rubber materials. Hyaloclastite of basaltic or intermediate-basaltic chemistry also improves the thermal stability and fire resistance of natural rubber and polymeric rubber materials. Hyaloclastite when ground to a fine powder provides good natural rubber and polymer rubber-filler interactions, including adsorption of polymer chains on the hyaloclastite, or lava quenched by water high, particle surface. Given the high thermal capacity of hyaloclastite, by absorbing significant amounts of heat, hyaloclastite acts as a thermal shield that protects the natural rubber and polymeric rubber from both degradation and destruction processes when exposed to high temperature. Thermally stable hyaloclastite of basalt or intermediate-basaltic chemistry, does not undergo any substantial thermal transformations at temperatures usually associated with burning of rubber, positively influences the structure of the boundary layer formed during thermal decomposition and combustion, effectively impeding the mass and energy flow between a hyaloclastite filler-based natural rubber and polymeric rubber and a flame.

Hyaloclastite, or lave quenched by water, of basaltic or intermediate-basaltic chemistry has a hardness of 6-7 on the Mohs scale and when in a fine powder to be used as a filler improves the flexural and compressive strength of natural rubber and polymeric rubber materials as well as other physical properties such a wear.

Hyaloclastite is a tuff-like breccia typically rich in black volcanic glass, formed during volcanic eruptions under water, under ice or where subaerial flows reach the sea or other bodies of water when lava is quenched by water. It has the appearance of angular fragments sized from less than approximately one millimeter to a few centimeters. Larger fragments can be found up to the size of pillow lava as well. Several minerals are found in hyaloclastite masses including, but not limited to, sideromelane, tachylite, palagonite, olivine, pyroxene, magnetite, quartz, hornblende, biotite, hypersthene, feldspathoids, plagioclase, calcite and others. Fragmentation can occur by both an explosive eruption process or by an essentially nonexplosive process associated with the spalling of pillow basalt rinds by thermal shock or chill shattering of molten lava. The water-quenched basalt glass is called sideromelane, a pure variety of glass that is transparent, and lacks the very small iron-oxide crystals found in the more common opaque variety of basalt glass called tachylite. In hyaloclastite, these glassy fragments are sometimes surrounded by a matrix of yellow-to-brown palagonite, a wax-like substance that forms from the hydration and alteration of the sideromelane and other minerals. Depending on the type of lava, the amount and pressure of the water quenching the lava, the rate of quenching or cooling and the amount of lava fragmentation, the particle of the volcanic glass (sideromelane) can be mixed with other volcanic rocks or crystalline minerals, such as olivine, pyroxene, magnetite, quartz, plagioclase, calcite and others. Alternatively, or additionally, the composition of the lava may contain crystals within the magma chamber prior to the volcanic eruption causing these crystals to be suspended in the lava matrix regardless of the amount or type of water quenching during the eruptions process. Lava quenched by water, regardless of the various percentages of amorphous or crystalline has different properties than lava of the same chemistry from a subaerial eruption where lave cools slowly over time and may contain similar types of crystalline minerals. In other words, rapidly cooled lava quenched by water has more desirable properties for the present invention than lava from a subaerial eruption that cools slowly over time. As such for the purpose of this invention the term “lava quenched by water” in whole or in part description is interchangeable with the term “hyaloclastite”.

Hyaloclastite is usually found within or adjacent subglacial volcanoes, such as tuyas, which is a type of distinctive, flat-topped, steep-sided volcano formed when lava erupts under or through a thick glacier or ice sheet. Hyaloclastite ridges are also called tindars and subglacial mounds are called tuyas or mobergs. They have been formed by subglacial volcanic eruptions during the last glacial period. A subglacial mound is a type of subglacial volcano. This type of volcano forms when lava erupts beneath a thick glacier or ice sheet. The magma forming these volcanoes was not hot enough to melt a vertical pipe through the overlying glacial ice, instead forming hyaloclastite and pillow lava deep beneath the glacial ice field. Once the glacier retreated, the subglacial volcano was revealed, with a unique shape as a result of its confinement within the glacial ice. Subglacial volcanoes are somewhat rare worldwide, being confined to regions that were formerly covered by continental ice sheets and also had active volcanism during the same period. Currently, volcanic eruptions under existing glaciers may create hyaloclastite as well.

Hyaloclastite tuff-like breccia is a pyroclastic rock comprised of glassy juvenile clasts contained in a fine-grained matrix dominated by glassy shards. Hyaloclastite breccias are typically products of phreatomagmatic eruptions in particular associated with the eruption of magmas into bodies of water and formed by fragmentation of chilled magma. They are often formed from basaltic magmas and are associated with pillow lavas and sheet flows. In addition, any other type of lava, such as intermediate-basaltic, andesitic, dacitic and rhyolitic, can form hyaloclastite under similar rapid cooling or quenching conditions.

Sometimes a subglacial or subaquatic eruption may produce a release of volcanic ashes that are ejected into the atmosphere through the water, which can then land back on the water's surface or on the ground. At times a fine volcanic particle size may be called a “volcanic ash” by different professionals in the geological field even though the ash definition may be debatable as it had originated from under water or phreatomagmatic eruption. It is also possible that a subglacial or subaquatic eruption may have been produced by a magma with a high volume of gas entrapped in the lava. The high volume of gas exsolution may create a mineral particle with very high porosity or vesicular structure and bulk density similar to scoria or pumice. For the purpose of this invention we call all of these “hyaloclastite” so long as the lava has been at least partially quenched by water.

Natural volcanic minerals, such as lava quenched by water or hyaloclastite, can be classified based on the amount of silica content as: basaltic (less than 53% by weight SiO₂), intermediate-basaltic (approximately 53-57% by weight SiO₂), or silicic such as andesitic (approximately 57-63% by weight SiO₂), dacitic (approximately 63-69% by weight SiO₂), or rhyolitic (greater than 69% by weight SiO₂). However, for the purpose of this invention the basaltic range starts at 40% SiO₂ and the intermediate-basaltic range ends at 60% SiO₂.

Basaltic lava quenched by water or hyaloclastite, contains generally 40% to 53% by weight silica (SiO₂) contained in an amorphous or crystalline form or a combination thereof comprising essentially calcic plagioclase feldspar and pyroxene (usually Augite), with or without olivine. In addition to silica, basaltic lava quenched by water or hyaloclastite, generally comprises approximately 10 to approximately 18 percent by weight Fe₂O₃, approximately 6 to approximately 18 percent by weight CaO, approximately 5 to approximately 15 percent by weight MgO and other elements in various percentages.

Intermediate basaltic lava quenched by water or hyaloclastite, generally comprises approximately 53 to approximately 57 percent by weight silica (SiO₂) content. In addition to silica, intermediate basaltic lava quenched by water or hyaloclastite generally comprises approximately 5 to approximately 10 percent by weight Fe₂O₃, approximately 6 to approximately 10 percent by weight CaO, approximately 3 to approximately 10 percent by weight MgO and other elements in various percentages. Basaltic or intermediate-basaltic lava quenched by water or hyaloclastite may also contain quartz, hornblende, biotite, hypersthene (an orthopyroxene) and feldspathoids.

However, for the purpose of this invention the basaltic range starts at approximately 40% SiO₂ and the intermediate-basaltic range ends at approximately 60% SiO₂

The average specific density of basaltic or intermediate basaltic lava quenched by water or hyaloclastite, is approximately 2.5-3.0 gm/cm³, preferably 2.6-2.9, and more preferably 2.75-2.85.

TABLE 1
Specific gravity of conventional rubber fillers vs. hyaloclastite
in accordance with the present invention

| Filler Material | Specific Gravity (gr/cm3) |
|---|---|
| Carbon Black | 1.8 |
| Precipitated Silica | 2 |
| Kaolin | 2.4 |
| Calcium Carbonate | 2.7 |
| Basaltic Hyaloclastite | 2.8-2.9 |
| Intermediate-Basaltic Hyaloclastite | 2.6-2.8 |

Volcanic minerals with high silica content have a lower specific gravity than minerals with lower silica content. Pure silica, such as precipitated silica, has a specific gravity of 2 compared to basaltic hyaloclastite with a silica content of 48% that has a specific gravity of 2.8 gr/cm³. Clays, such as kaolin, have a specific gravity of 2.6 but when calcined it can drop to 2.3-2.4 gr/cm³. Rubber compounds require a higher loading of fillers of lower specific gravity compared to a filler of higher specific gravity. Hyaloclastite rubber fillers in accordance with the present inventions have the highest specific density/gravity of any current mineral rubber fillers. This results in a reduced amount of filler being needed for a similar application.

The crystalline minerals contained within basaltic or intermediate-basaltic volcanic lava quenched by water or hyaloclastite, when ground to a small particle size have good filler properties for use in natural rubber or polymeric rubber materials. Therefore, a natural mineral filler from a basaltic, intermediate-basaltic mineral source is far more desirable to be used as natural mineral filler in accordance with the present invention than a natural mineral filler from an andesitic, dacitic or rhyolitic chemistry source.

As used herein, the term “hyaloclastite” shall mean lava quenched by water, in whole or in part, or hyaloclastite of basaltic or intermediate basaltic composition; i.e., all lava quenched by water or hyaloclastites of basaltic or intermediate basaltic composition, or its crystalline or amorphous compositions or combination thereof, with an amorphous content of 0-100% and a crystalline content of 0-100% wherein the crystalline matrix is comprised of various types of crystals, unless otherwise designated.

TABLE 2
Desirable chemical compositions for a natural mineral filler for rubber materials

| Elements | LS36-10 | TDR | SND | AB | BKP | PVT | RDF | THR | VCR | PTR |
|---|---|---|---|---|---|---|---|---|---|---|
| SiO₂ | 45.20 | 45.00 | 47.70 | 47.20 | 46.36 | 48.50 | 50.60 | 52.85 | 54.94 | 60.39 |
| Al₂O₃ | 14.09 | 17.60 | 15.33 | 12.49 | 11.96 | 15.40 | 15.00 | 14.53 | 14.87 | 13.05 |
| Total SiO₂, | 59.29 | 62.60 | 63.03 | 59.69 | 58.32 | 63.90 | 65.60 | 67.38 | 69.81 | 73.44 |
| Al₂O₃ | | | | | | | | | | |
| CaO | 14.77 | 12.70 | 11.51 | 11.51 | 9.68 | 9.37 | 9.16 | 8.94 | 8.84 | 6.69 |
| MgO | 6.11 | 7.27 | 10.89 | 11.06 | 5.50 | 6.57 | 7.78 | 4.94 | 4.93 | 6.37 |
| FeO | 13.07 | 12.90 | 12.75 | 12.04 | 15.38 | 13.00 | 10.20 | 12.03 | 9.85 | 7.21 |
| Total CaO, | 33.95 | 32.87 | 35.15 | 34.61 | 30.56 | 28.94 | 27.14 | 25.91 | 23.62 | 20.27 |
| MgO, FeO | | | | | | | | | | |
| Na₂O | 3.22 | 1.83 | 1.58 | 1.72 | 2.60 | 3.40 | 3.34 | 2.69 | 2.63 | 2.23 |
| K₂O | 1.12 | 0.21 | 0.21 | 0.40 | 0.70 | 1.14 | 1.48 | 0.76 | 0.86 | 2.27 |
| Total Alkali | 4.34 | 2.04 | 1.79 | 2.12 | 3.30 | 4.54 | 4.82 | 3.45 | 3.49 | 4.50 |

Different volcanic minerals, including lava quenched by water or hyaloclastites, have different amounts of amorphous glass and crystalline content. The oxides shown in Table 2 above is a method of determining the chemical composition and may not be a reflection of actual free oxides present within the matrix by themselves. The elements of the oxides are or may be part of complex formula of amorphous or microcrystalline structure or a combination thereof.

Olivine group minerals, belonging to the isolated tetrahedra silicate subclass, all have similar atomic arrangements. By far, the most important mineral of this group is called olivine. In contrast with some of the other silicates previously discussed, olivine chemistry is quite simple. Its general formula is (Mg, Fe, Ca, Mn)₂SiO₄ but Mn and Ca are often omitted because they are normally minor components.

Pyroxenes contain many different elements, but all pyroxenes have the general formula (Ca, Na, Mg, Fe)(Mg, Fe, Al)(Si, Al)₂O₆. The most common pyroxenes are close to Ca(Mg, Fe)Si₂O₆ or (Mg, Fe)₂Si₂O₆ in composition.

Amphiboles and pyroxenes are closely related minerals that commonly coexist. Both are chain silicates, but the atomic arrangement in amphiboles is more complex than in pyroxenes. Like pyroxenes, amphibole chemistry is highly variable and yields many different end member formulas. Also, like the pyroxenes, amphiboles fall into two main series: the orthoamphibole series and the clinoamphibole series. The amphiboles general formula is (K, Na)₀₋₁(Ca, Na, Mg)₂(Mg, Fe, Al)₅(Si, Al)₈O₂₂(OH)₂

Feldspars are the most abundant minerals in the Earth's crust. Their compositions vary but may be described with the general formula (Ca, Na, K)(Si, Al)₄O₈. Feldspar structures are based on SiO₄ and AlO₄ tetrahedra linked to form a three-dimensional framework. They form two series that share one end-member composition: the alkali feldspar series (mainly NaAlSi₃O₈—KAlSi₃O₈) and the plagioclase (mainly NaAlSi₃Os—CaAl₂Si₂O₈) series, alkali feldspars range in composition from albite (NaAlSi₃O₈) to orthoclase (KAlSi₃O₈). They also contain minor amounts of anorthite (CaAl₂Si₂O₈). Plagioclase feldspars are mostly solid solutions of albite (NaAlSi₃O₈) and anorthite (CaAl₂Si₂O₈). They commonly contain lesser amounts of orthoclase (KAlSi₃O₈), especially at high temperatures

K-rich feldspar may be either of three polymorphs: sanidine, orthoclase, or microcline. The three differ in the way SiO₄ and AlO₄ tetrahedra are distributed in their structures. Sanidine, the high-temperature polymorph, is most disordered; microcline, the low-temperature polymorph, is most ordered. Orthoclase has intermediate and somewhat variable ordering. Na-rich feldspar, too, has different polymorphs; they include monalbite at high temperature and low-albite at low temperature

Orthoclase comes from the Greek word orthos (right angle) and klasis (to break), referring to this mineral's perpendicular cleavages. The formula is KAlSi₃O₈. The luster, hardness and color of orthoclase may be similar to other feldspars, but (in contrast with plagioclase) orthoclase is frequently tan, pink, or flesh colored (plagioclase is usually white). Orthoclase has cleavage planes that meet at about 90 degrees, like other feldspars, but orthoclase does not show twin striations like plagioclase does.

Chemical compositions as reported herein are measured by the XRF (X-ray fluorescence) method. This is a non-destructive analytical technique used to determine the elemental composition of materials. XRF analyzers determine the chemistry of a sample by measuring the fluorescent (or secondary) X-ray emitted from a sample when it is excited by a primary X-ray source. Each of the elements present in a sample produces a set of characteristic fluorescent X-rays (“a fingerprint”) that is unique for that specific element, which is why XRF spectroscopy is an excellent technology for qualitative and quantitative analysis of material composition. The chemical analysis reported herein is the total oxides scan.

Sample preparation for XRF can be achieved using either of two distinct methods: a pressed powder and a fused glass disk. Pressed powder specimens are typically ground in a tungsten carbide ring and puck mill with a binding agent to reduce the particle size and provide a packed powder mount that will remain intact for transport and analysis. The advantages of this preparation method include the simplicity and better detection limits while disadvantages include what is known as the “mineralogical effect”, which requires a similar matrix between a bracketed calibration and unknown specimens for the calibrations to be valid.

Minerals with basaltic and intermediate-basaltic chemistry are the most thermally stable minerals. As the amount of silica increases, the thermal expansion of the mineral increases. Therefore, minerals with basaltic and intermediate-basaltic chemistry are most desirable to be used as a mineral filler for natural rubber and polymeric rubber materials to improve thermal stability, heat build-up, scorch risk, flame spread and fire resistance properties.

TABLE 3
Thermal expansion of rocks for the temperature interval 20-100° C.

| | Volumetric thermal expansion¹ |
|---|---|
| Rock type | (10⁻⁵ per ° C.) |
| Granite, rhyolite | 2.40 |
| Diorite, andesite | 2.10 |
| Gabbro, basalt | 1.60 |
| Sandstone | 3.00 |
| Quartzite | 3.30 |
| Limestone | 2.40 |
| Marble | 2.10 |
| Slate | 2.70 |

¹Mean volumetric thermal expansion, (X = (1/V0) (A V/A T), in units of 10⁻⁵ per ° C., from Skinner (1966)

Hyaloclastite, or lava quenched by water, with a basaltic or intermediate-basaltic chemical compositions is an inert and very stable natural mineral with high mechanical and thermal resistance as compared with all other mineral types. Natural rubber and polymeric rubber materials reinforced with hyaloclastite, or lava quenched by water, with basaltic or intermediate basaltic composition in powder form have enhanced properties such as improved rigidity, hardness, and thermal resistance. Hyaloclastite, or lava quenched by water, mineral filler contributes to the decrease of the heat release rate, indicating its usefulness as a flame-retardant material thus improving heat build-up, scorch risk, flammability and fire resistance of the natural rubber or polymeric rubber materials using type of mineral filler in accordance with the present invention.

TABLE 4
Thermal Conductivity of Some Geosilicate
Crystals, Glasses and Melts at 1 bar

| | | Thermal | |
|---|---|---|---|
| | Temperature | Conductivity | |
| Composition and state | (° C.) | (W/m K) | Source* |
| Olivine (Fo90) | 800 | 2.69 | (1) |
| | 1400 | 2.18 | (1) |
| Forsterite (Olivine) | 400 | 2.47 | (1) |
| | 800 | 1.84 | (1) |
| | 1400 | 1.59 | (1) |
| Orthopyroxene (Bronzite) | 0 | 4.62 | (1) |
| | 300 | 3.05 | (1) |
| Clinopyroxene (Diopside) | 20 | 4.27 | (1) |
| Obsidian (rhyolite glass) | 0 | 1.34 | (1) |
| | 300 | 1.67 | (1) |
| | 500 | 1.89 | (1) |
| Basalt glass (Hyaloclastite) | 0 | 1.15 | (1) |
| | 300 | 1.48 | (1) |
| SiO₂ (glass) | 600 | 1.76 | (1) |
| | 1230 | 1.87 | (1) |
| Plagioclase (Albite glass) | 25 | 1.37 | (2) |
| | 800 | 1.56 | (2) |
| Plagioclase (Anorthite glass) | 25 | 1.13 | (2) |
| | 800 | 1.43 | (2) |
| Pyroxene (Augite/Diopside | 25 | 1.24 | (2) |
| glass) | 800 | 1.46 | (2) |

*(1) Clark (1966); (2) Hofmeister et al. (2009);

Minerals with basaltic and intermediate-basaltic chemistry have the lowest thermal conductivity, as such making them one of the best mineral fillers to improve natural rubber and polymeric rubber material properties. As the amount of silica increases, so does the thermal conductivity of the mineral increase. Also, minerals with the same chemical composition found in an amorphous state generally have a lower thermal conductivity than the same mineral in a crystalline form. The type of crystals found in a crystalline mineral also seem to indicate different thermal conductivity coefficient. Therefore, minerals with basaltic and intermediate-basaltic chemistry are most desirable to be used as natural rubber and polymeric rubber mineral fillers to improve thermal conductivity and minerals in amorphous state are more desirable as well for flame spread and fire resistance properties. However, based on the desired property outcome these parameters have to be balanced toward the end goal. Therefore, in accordance with the present invention the lower the silica content the better the mineral is to be used as a filler to improve natural rubber and polymeric rubber material properties.

Hyaloclastite, or lava quenched by water, of basaltic or intermediate-basaltic chemistry is one of the hardest volcanic minerals to crush, grind or mill. As the SiO₂ increases, the hardness decreases. The hardness of the mineral is a determining factor in how the mineral fractures or breaks-up into smaller particles. A hard mineral breaks up in a more angular, rough particle shapes with many more concavities on the surface and generally in a more elongated shapes rather than a more circular shape. We call this particle shape type, a complex irregular polyhedron with a multitude of convex and concave planes oriented at random angles and having random sizes and shapes but generally of a more elongated rather than isometric prism or spherical shape such as the type of the particle shapes of current rubbers fillers. The irregular complex polyhedron can also have one or more vesicular cavities connected to the surface thereof. We call this a rough particle surface. A rougher particle will have a greater surface area compared to a particle with a smoother surface. A particle of the same size with more cavities or pores will have an even greater surface area than a particle of the same size without cavities or pores. In other words, hyaloclastite, or lava quenched by water, when ground to a small particle size, such as a powder, the exterior surface of the particle's rough surface allows for better adsorption and adhesion of the natural rubber or polymeric rubber to the mineral filler thereby improving physical properties of the natural rubber or polymeric rubber material containing such hyaloclastite mineral filler while using a filler of greater particle size than for example carbon black or precipitated silica. The rougher and more irregular the polyhedral surface of the individual particles, and the more micro or nano pores or cavities on the surface, the better the physical performance of the natural rubber or polymeric rubber product, such as tires, hoses, sheets or membranes.

The significance of particle shape in many industrial materials is frequently disregarded or undervalued. However, the particle shape and its properties play a key role and it is a key feature of the present invention. It is well known that the specific type of breakage affects the particle shape of mill products. For example, massive fracture generally leads to a non-spherical particle, which has sharp edges exposed at the intersection of progressive cracks, whereas attrition mode makes particles round by chipping of the edges and corners or abrasing of the surface. As particle sizes and applied stresses often follow normal distributions, it is very natural to obtain a distribution of product shapes.

Therefore, milling conditions that use an appropriate breakage mode play a crucial role in controlling the morphology of the final product. Moreover, the desired morphology of the filler particle in accordance with the present invention requires choosing the right device to achieve the desired particle shape. For example, roller press mills, ring roll mills, and hammer mills have been reported to produce mill products with decreasing particle roundness. It is this inventor's observation that particles with high circularity and low aspect ratio values can be produced by using a ball mill while particles with low circularity and high aspect ratio values can be obtained by using a roller mill. In addition, high pressure grinding roll (HPGR) mills can further increase the high aspect ratio of the particle size by fracturing mineral in a fiber like shape. In other words retention systems such as ball mills create more rounded particles, whereas single-pass devices such as roll crushers typically produce more elongated and angular particles. In addition, the following specific shapes of particles can be obtained by using specific crushers and mills: cubical products from an impact mill (one pass), cubical products from a roll crusher, sharp products from a gyratory crusher, spherical abrasive particles by a cyclone with walls, round products by autogenous grinding, the highest elongated particles from rod mill processing compared to the ball and autogenous mill. In addition, it has been reported that materials having globular, cigar-shaped, and flaky particles can be prepared by grinding using a hammer, disc, ball mill and vibratory pulverizer, respectively. Alternatively, hyaloclastite, or lava quenched by water, filler in accordance with the present invention can be processed in multiple stages. As an example, the initial raw mineral can be placed first in an HPGR, roller plate mill or rod mill where a more elongated angular shape particle is fractured and brought to a desired particle size. The size and shape of this particle size may be suitable for applications where a more plate-like or elongated shape is desired. Subsequently, the particles processed by the HPGR, roller plate mill or rod mill can be further processed in a ball mill or impact mill both to reduce the particle size or to change the particle shape to a lower aspect ratio, or a more rounded or blocky shape. However, the irregular polyhedral shape of the initial HPGR, roller plate mill or rod mill fracture with its multitude of convex and concave planes are retained as the ball mill works to create a more rounded particle shape. As a more specific example the hyaloclastite, or lava quenched by water, raw mineral can be placed first in an HPGR, roller plate mill or rod mill where a more elongated, angular shape particle is fractured and brought to a 40-150 micron mean particle size. The size and shape of this particle size can be suitable for applications where a more plate-like or elongated shape is desired. Subsequently, the particles processed by the HPGR, roller plate mill or rod mill with a mean particle size of a 40-150 micron is further processed in a ball mill, jet mill or impact mill both to reduce the particle size or to change the particle shape to a lower aspect ratio, or a more rounded or blocky shape to a mean particle size of 0.1-20 micron. However, the irregular polyhedral shape of the initial HPGR, roller plate mill or rod mill fracture with its multitude of convex and concave planes are retained as the ball mill or jet mill works to create a more rounded particle shape

TABLE 5
Mohs scale Hardness of various minerals:

| Mineral | Hardness |
|---|---|
| Diamond | 10 |
| Quartz | 7 |
| Zircon | 6.5-7.5 |
| Peridot/olivine | 6.5-7 |
| Basaltic Hyaloclastite | 6-7 |
| Plagioclase Feldspar | 6-6.5 |
| Orthoclase Feldspar | 6-6.5 |
| Titanium Oxide | 6 |
| Clinopyroxene | 5-7 |
| Silica (Precipitated) | 5.5 |
| Window Glass | 5-5.5 |
| Diopside/pyroxene | 5-6 |
| Obsidian | 5-5.5 |
| Zinc Oxide | 4.5 |
| Wollastonite | 4.5 |
| Dolomite | 3.5-4.5 |
| Calcite/Limestone | 3-4 |
| Barium Sulfate | 3-3.5 |
| Mica | 2.5-4 |
| Hyalosyte | 2.5 |
| Carbon Black | 2-3 |
| Kaolin | 2 |
| #2 Pencil Lead | 1 |
| Talc 1 | 1 |

Table 5 above shows some minerals currently used as fillers in the rubber and polymer industry and mineral fillers in accordance with the present invention (shown as underlined). Note that all other mineral fillers currently used in the natural rubber and polymeric rubber industry are softer than the hyaloclastite filler in accordance with the present invention. Hyaloclastite filler in accordance with the present invention has the highest hardness of all other fillers currently used in the rubber industry, thereby imparting this property to the rubber formulations and products using this mineral filler.

The hyaloclastite of basaltic or intermediate-basaltic chemistry in either amorphous form, crystalline form or a combination thereof are very hard minerals and when fractured by the grinding process are suitable to create a particle shape with the desired properties in accordance with the present invention as described above.

Different types of milling or crushing equipment can create a more or less rough particle surface and the roughness also depends on the particle size and the time it is processed in the mill. A roller or rod mill tends to create a more elongated particle shape while a ball mill tends to create a rounder particle shape. A larger particle size tends to be more elongated versus a fine particle size that tends to be more rounded. The inventor has discovered that the surface and shape properties described above are a function of the hyaloclastite, or lava quenched by water, of the basaltic and intermediate basaltic chemistry in accordance with the present invention. Hyaloclastite, or lava quenched by water, or other minerals with chemistry of higher silica content, are gradually softer as the silica content increases, requiring less energy to process or crush, and generally creating a more isometric prismatic particle shape that may be of blocky, plate-like, disc or rounded particle shape with less polyhedral planes or cavities and generally a more convex rather than concave polyhedral shape. A more isometric prismatic or rounded particle shape has less surface area, the surface area is smoother instead of rough resulting in less surface area for the same particle size. This requires a filler with a much finer particle size that has the equivalent surface area of a much coarser particle that has the same surface area due to a rougher surface. The result is that natural rubber or polymeric rubber absorbs and/or adsorbs less efficiently and the chemical or physical bond between the natural rubber or polymer rubber and the mineral filler is less strong or that a much finer particle size filler is needed to accomplish the same result.

The type of grinding aid used in the milling process will reduce the energy required to process the mineral filler in accordance with the present inventions. A grinding aid has to be selected to be compatible with the desired natural rubber or polymeric rubber application. Generally, the use of a grinding aid will produce a slightly more rounded particle shape, however the filler in accordance with the present invention is still a generally elongated and rough particle shape of irregular polyhedron shape with convex and concave planes randomly oriented and displaced. This can be helpful when the hyaloclastite filler is intended to be used as a nucleating agent or when used in the production of certain types of modified rubbers, such as EPDM, or silicone rubber materials. It may also be desirable to use a grinding aid to create a slightly more rounded particle shape filler with better flow and viscosity properties compared to particles produced without the use of a grinding aid.

Similarly, fillers made from a softer mineral such as limestone, talc, mica and the like, when ground into a powder tend to be more rounded shapes, requiring less energy to process or crush, and generally with less polyhedral planes and cavities. We call this an isometric prismatic particle shape that may be of blocky, plate-like, disc or a rounded shape. These particle shapes generally have a more convex than concave polyhedral shape, being more rounded and spherical. A more rounded particle shape has less surface area, the surface area is smoother and as a result the natural rubber or polymeric rubber absorbs and/or adsorbs or bonds less efficiently and the chemical or physical bond between the mineral filler and natural rubber or polymeric rubber material is less strong. This is why most common fillers used in the rubber industry generally decrease rather than increase physical properties of natural rubber or polymeric rubber materials containing them as well as requiring filler of very fine particle size such as precipitated silica and carbon black.

Alternatively, the hyaloclastite, or lava quenched by water, with basaltic or intermediate-basaltic chemistry can be fractured in smaller particles to achieve desired properties as described above using high-powered microwave treatment. As an example, hyaloclastite, or lava quenched by water, can be fed by a conveyer belt into a microwave fluid bed dryer or oven.

Below are examples of hyaloclastite filler of basaltic chemistry processed in accordance with the present invention. Tables 6-8 shows the measurement of the following properties using a FlowCam 8000 by Fluid Imaging Technologies of Scarborough ME, USA: diameter, circle fit, circularity, roughness, aspect ratio, length, width, geodesic aspect ratio, geodesic length and geodesic thickness. The terms are defined as follows:

Diameter (Mean): is the average of the Diameter (ABD) (Area Based Diameter) and the Diameter (ESD) (Equivalent Spherical Diameter) where the (Area Based Diameter): is the diameter based on a circle with an area that is equal to the ABD Area and the (Equivalent Spherical Diameter) is the Mean value of 36 feret measurements where the Feret Measurement: The perpendicular distance between parallel tangents touching opposite sides of the particle. VisualSpreadsheet makes 36 measurements for each particle, one each 5 degrees between −90 degrees and +90 degrees. (real >0) and the Area (ABD) is the Number of pixels in the thresholded (binary) greyscale image converted to a measure of area by use of the calibration factor. (real >0).

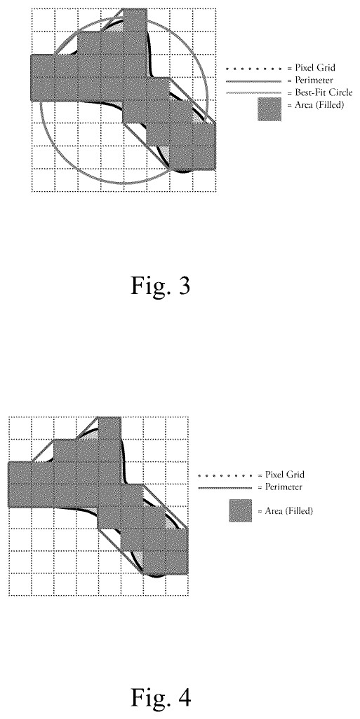

Circle Fit: deviation of the particle edge from a best-fit circle, normalized to the range [0,1] where a perfect fit has a value of 1. (real [0, 1]; 1 is the value for a perfect circle; values near zero are for particles that are not at all circular). See FIG. 3.

Circularity: a shape parameter computed from the perimeter and the (filled) area. A circle has a value of 1.0. Circularity is the inverse of Compactness. Formula: (4×π×Area)/Perimeter². (real [0,1])=Pixel Grid=Perimeter=Best-Fit Circle=Area (Filled). See FIG. 4.

Roughness: a measure of the unevenness or irregularity of a particle's surface-the ratio of perimeter to convex perimeter. (real >1; 1 is the value for a filled shape with convex perimeter; larger values are for particles that have interior holes and/or a non-convex perimeter).

Aspect Ratio: the ratio of the lengths of the axes of the Legendre ellipse of inertia of the particle. The Legendre ellipse of inertia is an ellipse with its center at the particle's centroid, and with the same geometrical moments, up to second order, as the original particle area. A circle has the value 1.0 as does a square. Values near zero are for particles that are long and thin. (real [0, 1]) Reference: ISO 9276-6:2008.

Length: the maximum value of 36 feret measurements. (real >0) where the Feret Measurement: The perpendicular distance between parallel tangents touching opposite sides of the particle. VisualSpreadsheet makes 36 measurements for each particle, one each 5 degrees between −90 degrees and +90 degrees. (real >0).

Width: the minimum value of 36 feret measurements. (real >0) where the Feret Measurement: The perpendicular distance between parallel tangents touching opposite sides of the particle. VisualSpreadsheet makes 36 measurements for each particle, one each 5 degrees between −90 degrees and +90 degrees. (real >0).

Geodesic Aspect Ratio: the ratio of Geodesic Thickness to Geodesic Length. Elongation is the inverse of this ratio. (real [0, 1]).

Geodesic Length and Geodesic Thickness: values obtained by modeling the particle as a rectangle and computing length and thickness by solving the equations:

Area=Geodesic Length×Geodesic Thickness

Perimeter=2×(Geodesic Length+Geodesic Thickness) where Area is filled area and Perimeter is the length of the particle edge not including the lengths of edges of holes in the particle. (real >0).

TABLE 6
Example of basaltic hyaloclastite ground in a ball mill to a volume-based mean particle
size of 12 micron with the particle properties in subranges as shown (see attached photo)

| Particle | | | | | | | | Geodesic | | |
|---|---|---|---|---|---|---|---|---|---|---|
| Size | Diameter | Circle | | | Aspect | | | Aspect | Geodesic | Geodesic |
| Range | (Mean) | Fit | Circularity | Roughness | Ratio | Length | Width | Ratio | Length | Thickness |
| 0.75-1 | 0.9432 | 0.7899 | 0.7357 | 1.4152 | 0.5590 | 1.3830 | 0.7131 | 0.6377 | 1.9890 | 1.0068 |
| micron | | | | | | | | | | |
| 1-2 | 1.4133 | 0.8473 | 0.8864 | 1.2962 | 0.7802 | 1.8962 | 1.2111 | 0.8610 | 2.3879 | 1.8489 |
| micron | | | | | | | | | | |
| 2-4 | 2.8400 | 0.8433 | 0.8891 | 1.1967 | 0.8225 | 3.5624 | 2.4154 | 0.9180 | 3.6863 | 3.2384 |
| micron | | | | | | | | | | |
| 4-8 | 5.2062 | 0.7322 | 0.8235 | 1.1436 | 0.7094 | 6.6720 | 4.1146 | 0.8709 | 6.1264 | 4.9897 |
| micron | | | | | | | | | | |
| 8-12 | 9.6728 | 0.5639 | 0.7272 | 1.1175 | 0.6251 | 12.8043 | 7.3604 | 0.6723 | 12.0146 | 7.3760 |
| micron | | | | | | | | | | |
| 12-16 | 13.7392 | 0.5126 | 0.6949 | 1.1161 | 0.6384 | 18.0626 | 10.7874 | 0.5870 | 17.7156 | 9.3968 |
| micron | | | | | | | | | | |
| 16-20 | 17.9029 | 0.5147 | 0.6973 | 1.1098 | 0.6526 | 23.0053 | 14.3284 | 0.5974 | 22.2835 | 12.2268 |
| micron | | | | | | | | | | |
| 20-24 | 22.0890 | 0.4530 | 0.6651 | 1.1098 | 0.6242 | 28.8601 | 17.3504 | 0.5311 | 28.8690 | 13.7848 |
| micron | | | | | | | | | | |
| 24-30 | 25.8914 | 0.3772 | 0.6464 | 1.1127 | 0.5712 | 34.8494 | 19.2014 | 0.4355 | 35.1756 | 14.7671 |
| micron | | | | | | | | | | |
| 30-45 | 34.3820 | 0.1588 | 0.5224 | 1.1666 | 0.4914 | 48.7370 | 24.9390 | 0.2770 | 55.4776 | 15.0294 |
| micron | | | | | | | | | | |

TABLE 7
Example of basaltic hyaloclastite ground in a ball mill to a volume-based mean particle size of 12 micron
processed using a grinding aid with particle properties in subranges as shown (see attached photo)

| | | | | | | | | Geodesic | | |
|---|---|---|---|---|---|---|---|---|---|---|
| Particle | Diameter | Circle | | | Aspect | | | Aspect | Geodesic | Geodesic |
| Size Range | (Mean) | Fit | Circularity | Roughness | Ratio | Length | Width | Ratio | Length | Thickness |
| 0.75-1 | 0.9458 | 0.7962 | 0.7565 | 1.4158 | 0.5728 | 1.3695 | 0.7180 | 0.6644 | 1.9346 | 1.0423 |
| micron | | | | | | | | | | |
| 1-2 micron | 1.4084 | 0.8472 | 0.8857 | 1.2976 | 0.7791 | 1.8921 | 1.2050 | 0.8566 | 2.3967 | 1.8286 |
| 2-4 micron | 2.8511 | 0.8395 | 0.8831 | 1.1983 | 0.8169 | 3.5841 | 2.4185 | 0.9091 | 3.7334 | 3.2297 |
| 4-8 micron | 5.2513 | 0.7306 | 0.8217 | 1.1440 | 0.7088 | 6.7316 | 4.1445 | 0.8746 | 6.1733 | 5.0337 |
| 8-12 | 9.6493 | 0.5824 | 0.7363 | 1.1173 | 0.6407 | 12.6106 | 7.4548 | 0.6952 | 11.7586 | 7.5240 |
| micron | | | | | | | | | | |
| 12-16 | 13.7804 | 0.4953 | 0.6898 | 1.1128 | 0.6210 | 18.2419 | 10.5182 | 0.5859 | 17.6686 | 9.4393 |
| micron | | | | | | | | | | |
| 16-20 | 17.7789 | 0.4403 | 0.6648 | 1.1158 | 0.5966 | 23.7021 | 13.6025 | 0.5086 | 23.7364 | 11.0869 |
| micron | | | | | | | | | | |
| 20-24 | 21.9769 | 0.4231 | 0.6616 | 1.1084 | 0.5907 | 29.6143 | 16.7095 | 0.5230 | 28.8777 | 13.6419 |
| micron | | | | | | | | | | |
| 24-30 | 27.0458 | 0.4494 | 0.6723 | 1.1099 | 0.6234 | 35.2943 | 21.3722 | 0.4995 | 34.8801 | 16.6386 |
| micron | | | | | | | | | | |
| 30-45 | 33.7842 | 0.3949 | 0.6320 | 1.1202 | 0.6388 | 43.1678 | 27.1938 | 0.4468 | 46.3779 | 18.9060 |
| micron | | | | | | | | | | |
| 45-60 | 53.244 | 0 | 0.428 | 1.077 | 0.27 | 98.615 | 29.829 | 0.194 | 101.021 | 19.646 |
| micron | | | | | | | | | | |

TABLE 8
Example of basaltic hyaloclastite ground in a roller plate Raymond mill to a volume-based mean particle
size of 12 micron processed using with the particle properties in subranges as shown (see attached photo)

| Particle | | | | | | | | Geodesic | | |
|---|---|---|---|---|---|---|---|---|---|---|
| Size | Diameter | | | | Aspect | | | Aspect | Geodesic | Geodesic |
| Range | (Mean) | Circle Fit | Circularity | Roughness | Ratio | Length | Width | Ratio | Length | Thickness |
| 0.5-1 | 0.9465 | 0.8053 | 0.7742 | 1.4191 | 0.5990 | 1.3529 | 0.7359 | 0.6985 | 1.8866 | 1.0745 |
| micron | | | | | | | | | | |
| 1-2 | 1.3918 | 0.8486 | 0.8871 | 1.3016 | 0.7825 | 1.8626 | 1.1951 | 0.8601 | 2.3661 | 1.8160 |
| micron | | | | | | | | | | |
| 2-4 | 2.8200 | 0.8364 | 0.8788 | 1.2009 | 0.8134 | 3.5654 | 2.3802 | 0.9066 | 3.7273 | 3.2016 |
| micron | | | | | | | | | | |
| 4-8 | 5.3528 | 0.7212 | 0.8185 | 1.1411 | 0.6969 | 6.9145 | 4.1824 | 0.8646 | 6.2869 | 5.0900 |
| micron | | | | | | | | | | |
| 8-12 | 9.7403 | 0.5574 | 0.7246 | 1.1157 | 0.6172 | 12.9375 | 7.3445 | 0.6614 | 12.1312 | 7.3805 |
| micron | | | | | | | | | | |
| 12-16 | 13.9108 | 0.5171 | 0.7076 | 1.1074 | 0.6312 | 18.2211 | 10.8152 | 0.6160 | 17.2940 | 9.8087 |
| micron | | | | | | | | | | |
| 16-20 | 17.9486 | 0.5152 | 0.7082 | 1.1015 | 0.6583 | 23.1138 | 14.3247 | 0.6107 | 21.8564 | 12.4590 |
| micron | | | | | | | | | | |
| 20-24 | 21.8091 | 0.4861 | 0.6985 | 1.1059 | 0.6424 | 28.0565 | 17.0610 | 0.5794 | 26.9768 | 14.5405 |
| micron | | | | | | | | | | |
| 24-30 | 26.4975 | 0.4981 | 0.7038 | 1.1015 | 0.6738 | 33.4731 | 21.5399 | 0.5963 | 32.0156 | 17.7562 |
| micron | | | | | | | | | | |
| 30-45 | 33.1187 | 0.4107 | 0.6270 | 1.1390 | 0.6493 | 42.4405 | 26.8577 | 0.4293 | 46.6652 | 18.3740 |
| micron | | | | | | | | | | |
| 45-65 | 56.3398 | 0.0155 | 0.3930 | 1.1990 | 0.3010 | 91.9320 | 32.2740 | 0.2000 | 112.7040 | 17.4760 |
| micron | | | | | | | | | | |

Hyaloclastite filler of basaltic or intermediate basaltic chemistry has a surface with higher hydrophobic properties than a filler with higher silica, such as precipitated silica. This results in a greater compatibility of physiochemical properties between the rubber and the filler in accordance with the present invention.

Hyaloclastite or lava quenched by water mineral deposits such as mobergs, tuyas and the like of young geological age, such as from the last glaciation to present, are chemically homogenous, unaltered and consistent. This allows a predictable performance of the hyaloclastite mineral filler in accordance with the present invention.

Table 9 below shows examples of hyaloclastites, or lave quenched by water, in whole or in part, that contain various amounts of amorphous and crystalline content. Samples 14 and 15 are rhyolitic glass such as perlite and the CaO content is below 1% compared with the basaltic in Samples 1-13 where CaO ranges between 9-16%.

TABLE 9

| | | Clinopyroxene | | | | |
|---|---|---|---|---|---|---|
| | | Ca(Mg, Fe, Al, Ti) | Plagioclase Feldspar | Olivine | | |
| | “Amorphous” | (Si, Al)2O6 | (Na, Ca)Al(Si, Al)3O8 | (Fe, Mg)2SiO4 | Calcite | Unidentified |
| 1 | >70 | — | 12 | 5 | 7 | <5 |
| 2 | >80 | | 10 | <5 | — | <5 |
| 3 | >70 | <3? | 11 | <5 | — | <5 |
| 4 | >80 | — | 13 | <3 | — | <5 |
| 5 | >55 | | 12 | 5 | 20 | <5 |
| 6 | >70 | — | 11 | 5 | <5 | <5 |
| 7 | >75 | — | 10 | 5 | — | <5 |
| 8 | >65 | — | 15 | 5 | <5 | <5 |
| 9 | >70 | <3? | 12 | 5 | | <5 |
| 10 | >30 | 25 | 43 | 5 | | <5 |
| 11 | >55 | | 15 | 5 | 15 | <5 |
| 12 | >40 | 17 | 37 | 4 | 1 | <5 |
| 13 | >70 | — | 15 | 8 | | <5 |
| 14 | >95 | | | | | <5 |
| 15 | >95 | | | | | <5 |

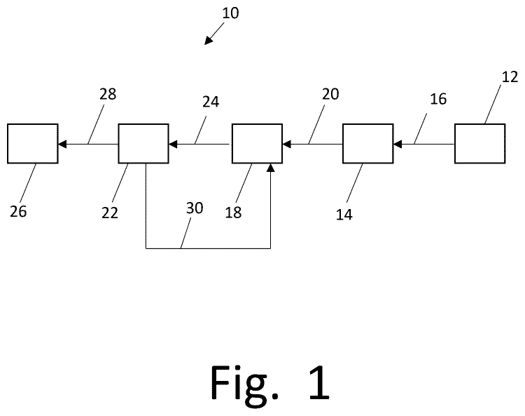

Referring now to FIG. 1, there is shown a flow diagram of a disclosed embodiment of a natural mineral filler processing plant 10 in accordance with the present invention. A natural volcanic mineral, such as hyaloclastite, or lava quenched by water, is mined from the ground at a mine site. Unprocessed volcanic mineral can have a particle size of about 1/32 to about ½ inch or in the range a very fine sand to gravel. It can also have a larger size of lava pillows or breccia. The volcanic mineral is transported from the mine site to the natural mineral processing plant 10 where it is deposited in a supply pile 12. The volcanic mineral in the supply pile 12 may have a moisture content of approximately 2 to 20% by weight. The volcanic mineral of particle sizes larger than sand may be reduced in size down to a 1/32 to ¼″ size by using a rock crusher (not shown). However, in order to reduce the particle size of the unprocessed volcanic mineral to the micron range by a dry process mill, it must have a moisture content of approximately 2% by weight or lower. Therefore, it is necessary to dry the unprocessed volcanic mineral. Accordingly, unprocessed volcanic mineral from the supply pile 12 is transported from the pile to a dryer 14 by a conveyor belt 16. The dryer 14 is typically a rotating drum, air blade or fluid bed (not shown) with a gas flame that projects into the drum or fluid bed or by an electric heating element. Helical flights or conveyer belts within the drum or fluid bed dryer move the hyaloclastite from the inlet of the drum or fluid bed to the outlet. The temperature inside the dryer is sufficiently high to allow for the desired reduction in moisture based on the moisture content of the materials fed into the dyer. From the dryer 14, the dried lava quenched by water or hyaloclastite, is transported to a micronizing mill 18 by either a conveyor belt or a screw conveyor 20. Certain types of mills, such a vertical roller mills, may have a built-in dryer or if the mineral feed moisture content is relatively low a drier may be optional. The mill 20 reduces the particle size of the lava or hyaloclastite from about 1/32 to about ½ inch size as it is mined from the ground, or pre-crushed by a rock crusher, to a desired particle size in the micron range. The micronizing mill can be a ball mil, a roller mill, a rod mill or any other type mill that can reduce a mineral down to the desired particle size. If a high aspect ratio particle size is desired, a vertical roller mill or a rod mill is a more desirable type mill to employ for the production of the natural mineral rubber filler. The micronizing mill can be a dry process mill circuit as described above or it can be a wet process mill circuit. From the mill 18, the reduced size lava quenched by water or hyaloclastite is lifted by the air flow into a particle size classifier 22 connected by a duct or pipe 24. The classifier separates particles that meet a desired size criteria from those that do not meet the criteria. Those particles that meet the size criteria are passed from the classifier 22 to a storage silo 26 by air flow or a screw conveyor 28. Those particles that are bigger than the size criteria are transported from the classifier 22 back to the input of the micronizing mill 18 by a retuning duct or pipe 30. The storage silo 26 is used to contain the lava quenched by water or hyaloclastite natural mineral natural rubber or polymeric rubber filler of the desires particle size range until it can be transported, such as by rail or truck, to a customer.

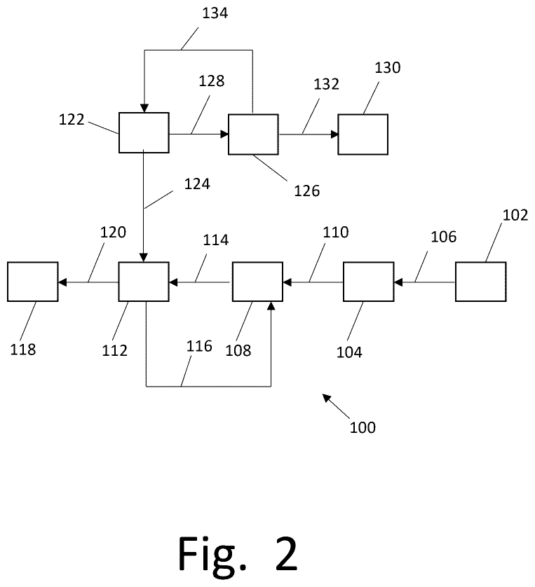

The foregoing process can be modified to include a two-mill grinding process (as described above in a manner within the ability of those skilled in the art. Referring now to FIG. 2, there is shown a flow diagram of another disclosed embodiment of a natural mineral filler two-stage processing plant 100 in accordance with the present invention. A natural volcanic mineral, such as hyaloclastite, or lava quenched by water, is mined from the ground at a mine site. The volcanic mineral is transported from the mine site to the natural mineral processing plant 100 where it is deposited in a supply pile 102. The volcanic mineral in the supply pile 102 may have a moisture content of approximately 2 to 20% by weight. The volcanic mineral of particle sizes larger than sand may be reduced in size down to a 1/32 to ¼″ by using a rock crusher (not shown). However, in order to reduce the particle size of the unprocessed volcanic mineral to the micron range by a dry process mill, it must have a moisture content of approximately 2% by weight or lower. Certain types of mills, such a vertical roller mills, may have a built-in dryer or if the mineral feed moisture content is relatively low a drier may be optional. Accordingly, unprocessed volcanic mineral from the supply pile 102 is transported from the pile to a dryer 104 by a conveyor belt 106. The dryer 104 is typically a rotating drum or fluid bed (not shown) with a gas flame that projects into the drum or fluid bed or by an electric heating element. Helical flights or conveyer belts within the drum or fluid bed dryer move the hyaloclastite from the inlet of the drum or fluid bed to the outlet. The temperature inside the dryer is sufficiently high to allow for the desired reduction in moisture based on the moisture content of the materials fed into the dyer. From the dryer 104, the dried hyaloclastite, or lava quenched by water, is transported to a HPGR, roller plate mill or rod mill 108 by either a conveyor belt or a screw conveyor 110. The mill 108 fractures the particles of hyaloclastite, or lava quenched by water, from about 1/32 to about ½ inch size as it is mined from the ground, or pre-crushed by a rock crusher, into more elongated angular shaped particles a desired particle size in the micron range, such as a volume-based mean particle size of about 40 to about 150 μm. If a high aspect ratio particle size is desired, a vertical roller mill or a rod mill is a more desirable type mill 108 to employ for the production of the natural mineral rubber filler.

In an alternative disclosed embodiment of the present invention, depending on the amount of moisture in the hyaloclastite, or lava quenched by water, supply pile 102 the dryer 104 can be eliminated from the processing plant 100. A substantial amount of heat is produced by the fracturing process in the mill 108. This heat combined with the air flow through the mill 108 can be sufficient to dry the hyaloclastite, or lava quenched by water, during the fracturing process. Such would be highly advantageous as the drying process requires a substantial amount of energy, typically from fossil fuels.

From the mill 108, the reduced size hyaloclastite, or lava quenched by water, is lifted by the air flow into a particle size classifier 112 connected by a duct or pipe 114. The classifier separates particles that meet a desired size criteria from those that do not meet the criteria. Those particles that do not meet the desired criteria; i.e., are bigger than the size criteria, are transported from the classifier 112 back to the input of the mill 108 by a retuning duct or pipe 116. Those particles that meet the desired size criteria are passed from the classifier 112 to one of two locations. If the size and shape of the particles emerging from the classifier 112 are desired for the final product, the processed hyaloclastite, or lava quenched by water, are transported from the classifier 112 to a storage silo 118 by a conveyor or a screw auger 120. The storage silo 26 is used to contain the processed hyaloclastite, or lava quenched by water, natural rubber or polymeric rubber filler of the desires particle size range until it can be transported, such as by rail or truck, to a customer.

Depending on the size and shape of the hyaloclastite, or lava quenched by water, desired for the final product, the hyaloclastite, or lava quenched by water, from the mill 112 can be transported to a micronizing mill 122, such as a ball mill, jet mill or impact mill, both to reduce the particle size or to change the particle shape to a lower aspect ratio, to a more rounded or blocky shape, by a conveyor or a screw auger 124. Whether the processed hyaloclastite, or lava quenched by water, from the mill 112 is fed to the conveyor or auger 120 or 124 is controlled by a shunt (not shown). But, the processed hyaloclastite, or lava quenched by water, from the mill 112 can selectively be fed to either the conveyor or auger 120 or the conveyor or auger 124, or both.

The micronizing mill 122 can be a dry process mill circuit as described above or it can be a wet process mill circuit. It is preferred that the particles of hyaloclastite, or lava quenched by water, processed in the mill 122 have a volume-based mean particle size of about 0.1 to less than 40 μm, more preferably about 0.1 to about 20 μm, most preferably about 0.1 to about 10 μm.

From the mill 122, the reduced size hyaloclastite, or lava quenched by water, is lifted by the air flow into a second particle size classifier 126 connected by a duct or pipe 128. The classifier separates particles that meet a desired size criteria from those that do not meet the criteria. Those particles that meet the size criteria are passed from the second classifier 126 to a second storage silo 130 by air flow or a screw conveyor 132. Those particles that are bigger than the size criteria are transported from the second classifier 126 back to the input of the micronizing mill 124 by a retuning duct or pipe 134. The storage silo 130 is used to contain the hyaloclastite, or lava quenched by water, natural rubber or polymeric rubber filler of the desires particle size range until it can be transported, such as by rail or truck, to a customer.

In a disclosed embodiment, the present invention is a natural mineral filler for natural rubber or polymeric rubber comprising lava quenched by water or hyaloclastite with a chemical composition preferably comprising approximately 40 to approximately 60 percent by weight SiO₂, approximately 10 to approximately 18 percent by weight Al₂O₃, 4 to approximately 20 percent by weight CaO, and optionally one or more of approximately 3 to approximately 15% MgO and approximately 4 to approximately 18 percent by weight Fe₂O₃, ground into powder form. The particle size of the natural mineral filler powder is sufficiently small such that the lava quenched by water or hyaloclastite powder has natural rubber or polymeric rubber filler properties. The natural mineral for natural rubber or polymeric rubber filler particle size in dry powder form preferably has a volume-based mean particle size of less than or equal to approximately 160 μm, more preferably less than or equal to approximately 140 μm, most preferably less than or equal to approximately 120 μm, especially less than or equal to approximately 100 μm, more especially less than or equal to approximately 80 μm, preferably less than or equal to approximately 60 μm, more preferably less than or equal to approximately 40 μm, most preferably less than or equal to approximately 20 μm, especially less than or equal to approximately 16 μm, more especially less than or equal to approximately 12 μm, most especially less than or equal to approximately 10 μm, preferably less than or equal to approximately 8 μm, more preferably less than or equal to approximately 4 μm, preferably less than or equal to approximately 2 μm and most preferably less than or equal to approximately 1 am. The foregoing ranges include all of the intermediate values. Different applications may require different particle sizes depending on the type of desired properties to be achieved. However, there are economic limits for grinding rock to small particle sizes. Those limits are well known by those skilled in the art. The natural mineral natural rubber or polymer rubber filler particle size in dry powder form preferably has a Blaine value of approximately 1000 to approximately 12,000, preferably approximately 1,500 to approximately 10,000, more preferably approximately 3,500 to approximately 10,000, most preferably approximately 4,500 to approximately 10,000, especially approximately 6,000 to approximately 10,000. The foregoing ranges include all of the intermediate values. The natural mineral polymer filler particle size in either dry powder or wet solution, preferably has a Blaine value of greater than or equal to approximately 10,000. As the natural mineral natural rubber or polymeric rubber filler particle size in either dry powder or wet solution, is ground to the desired particle size, such as in the micronizing mill 18, a suitable grinding aid can be used. The finished natural mineral natural rubber or polymeric rubber filler particle size in dry powder, that is collected from the particle size classifier 22 can be transported to the storage silo 26 using an enclosed or sealed screw conveyor 28 of a desirable diameter and length.

To achieve the desired particles size, lava quenched by water or hyaloclastite mineral can be ground using conventional mineral grinding equipment including, but not limited to, a ball mill, a roll mill or a plate mill. A particle size classifier can be used in conjunction with the mill to achieve the desired particle size. Equipment for grinding and classifying hyaloclastite to the desired particle size is commercially available from, for example, F. L. Smidth, Bethlehem, PA; Metso, Helsinki, Finland and others.

The ground hyaloclastite, or lava quenched by water, is then preferably classified by screening the powder with a 100-mesh screen or sieve. Preferably, approximately 60% by volume of hyaloclastite, or lava quenched by water, mineral powder passes through a 100-mesh screen, more especially approximately 80% by volume of hyaloclastite, or lava quenched by water, mineral powder passes through a 100-mesh screen more especially approximately 90% by volume hyaloclastite, or lava quenched by water, mineral powder passes through a 100-mesh screen, especially approximately 95% by volume hyaloclastite, or lava quenched by water, mineral powder passes through a 100-mesh screen and more especially approximately 100% by volume hyaloclastite, or lava quenched by water, powder passes through a 100-mesh screen. Preferably approximately 60% to approximately 100% by volume hyaloclastite, or lava quenched by water, powder passes through a 100-mesh screen, preferably approximately 80% to approximately 100% by volume hyaloclastite, or lava quenched by water, powder passes through a 100-mesh screen, preferably approximately 90% to approximately 100% by volume hyaloclastite, or lava quenched by water, powder passes through a 100-mesh screen, most preferably approximately 95% to approximately 100% by volume hyaloclastite, or lava quenched by water, mineral powder passes through a 100-mesh screen, especially approximately 100% by volume hyaloclastite, or lava quenched by water, mineral powder passes through a 100-mesh screen. The foregoing ranges include all intermediate values. In another embodiment the ground hyaloclastite, or lava quenched by water, is then preferably classified by screening the powder with a 200-mesh screen or sieve. Preferably approximately 90% by volume hyaloclastite, or lava quenched by water, mineral powder passes through a 200-mesh screen, especially approximately 95% by volume hyaloclastite, or lava quenched by water, mineral powder passes through a 200-mesh screen and more especially approximately 200% by volume hyaloclastite, or lava quenched by water, powder passes through a 200-mesh screen. Preferably approximately 90% to approximately 100% by volume hyaloclastite, or lava quenched by water, powder passes through a 200-mesh screen, most preferably approximately 95% to approximately 100% by volume hyaloclastite, or lava quenched by water, mineral powder passes through a 200-mesh screen, especially approximately 100% by volume hyaloclastite, or lava quenched by water, mineral powder passes through a 200-mesh screen. The foregoing ranges include all intermediate values. In yet another embodiment the ground hyaloclastite, or lava quenched by water, is then preferably classified by screening the powder with a 300-mesh screen or sieve. Preferably approximately 90% by volume hyaloclastite, or lava quenched by water, mineral powder passes through a 300-mesh screen, especially approximately 95% by volume hyaloclastite, or lava quenched by water, mineral powder passes through a 300-mesh screen and more especially approximately 100% by volume hyaloclastite, or lava quenched by water, powder passes through a 300-mesh screen. Preferably approximately 90% to approximately 100% by volume hyaloclastite, or lava quenched by water, powder passes through a 300-mesh screen, most preferably approximately 95% to approximately 100% by volume hyaloclastite, or lava quenched by water, mineral powder passes through a 300-mesh screen, especially approximately 100% by volume hyaloclastite, or lava quenched by water, mineral powder passes through a 300-mesh screen. The foregoing ranges include all intermediate values.

In one disclosed embodiment of the present invention, hyaloclastite, or lava quenched by water, preferably has a chemical composition of approximately 40% to approximately 65% by weight SiO₂, approximately 10% to approximately 18% by weight Al₂O₃, 4% to approximately 20% by weight CaO, approximately 3% to approximately 15% by weight MgO, approximately 4% to approximately 18% by weight Fe₂O₃. In addition to the foregoing, other compounds can be present in small amounts, such as K₂O, TiO₂, P₂O₅, MnO, various metals, rare earth trace elements and other unidentified elements. When combined, these other compounds represent less than 10% by weight of the total chemical composition of the lava quenched by water or hyaloclastite mineral.

In another disclosed embodiment, the lava quenched by water or hyaloclastite mineral filler in accordance with the present invention preferably has a density or specific gravity of approximately 2.6 to approximately 3.1, preferably 2.6-2.9, and more preferably 2.75-2.85. The foregoing ranges include all intermediate values.

In another disclosed embodiment, the hyaloclastite, or lava quenched by water, mineral filler in accordance with the present invention preferably has a hardness on the Mohs scale of 5.5-8, preferably 6-7.5, more preferably 6.5-7.5. The foregoing ranges include all intermediate values.

Hyaloclastite, or lava quenched by water, in whole or in part, in accordance with the present invention can be in crystalline or amorphous (glassy) form and is usually found as a combination of both in varying proportions. Preferably, hyaloclastite, or lava quenched by water, in accordance with the present invention comprises approximately 0% to 100% by weight amorphous form, more preferably approximately 10% to approximately 80% by weight amorphous form, most preferably approximately 20% to approximately 60% by weight amorphous form, especially approximately 30% to approximately 50% by weight amorphous form. The crystalline portion of hyaloclastite, or lava quenched by water, preferably comprises approximately 3% to approximately 20% by weight olivine, approximately 5% to approximately 40% by weight clinopyroxene, approximately 5% to approximately 60% by weight plagioclase, and approximately 0% to approximately 40% (or less than 40%) by weight other minerals including, but not limited to, magnetite, UlvoSpinel, quartz, feldspar, pyrite, illite, hematite, chlorite, calcite, hornblende, biotite, K-feldspars, mordenite, clinoamphibole, ilmenite hypersthene (an orthopyroxene), feldspathoids sulfides, metals, rare earth minerals, other unidentified minerals and combinations thereof. The foregoing ranges include all of the intermediate values.

Hyaloclastite, or lava quenched by water, filler in accordance with the present invention preferably can be added to natural rubber or polymeric rubber in amounts of approximately 0.1% to approximately 95% by weight, more preferably approximately 0.1% to approximately 50% by weight, most preferably approximately 0.1% to approximately 25% by weight, especially approximately 0.1% to approximately 10% by weight, more especially approximately 0.1% to approximately 5% by weight, depending on the application and particle size of the filler needed to achieve the desired properties. Furthermore, the amount of hyaloclastite, or lava quenched by water, in accordance with the present invention that can be added to natural rubber or polymeric rubber depends on the viscosity needed for a particular natural rubber or polymeric rubber application. Generally speaking, the greater the amount of filler added and the smaller the particle size of the filler added, the lower the viscosity of the natural rubber or polymeric rubber composition. The foregoing ranges are applicable to the addition of hyaloclastite, or lava quenched by water, to all natural rubber or polymeric rubber materials including, but not limited to, solid natural rubber or polymeric rubber materials, such as natural rubber, styrene-butadiene rubber (SBR), butyl rubber (IIR), nitrile (NBR), neoprene/chloroprene (CR), ethylene propylene diene monomer rubber (EPDM), silicone rubber (Q), fluoroeleastomer/viton (FKM), polyurethane (AU), hydrogenated nitrile (HNBR), acrylic rubber (ACM), chlorosulfonated polyethylene rubber (CSM), polychloroprene rubber (CR), isoprene rubber (IR), fluoroelastomers (FKM) perfluoroelastomer rubber (FFKM), polysulfide rubber (PSR) and many other less common types of rubber or combinations or mixtures of the above.

The hyaloclastite mineral filler can be made of ground lava quenched by water of any chemistry in the range of the basaltic to intermediate-basaltic as defined above. Irrespective of the chemical composition of the lava, the hyaloclastite mineral filler useful in the present invention should have a pH in deionized water of not greater than 8.4. Preferably, the hyaloclastite mineral filler can be made of lava quenched by water of any chemistry in the range of the basaltic to intermediate-basaltic or andesitic useful in the present invention has a pH in deionized water of about 7 to 8.4.

The hyaloclastite mineral filler in accordance with this invention can be used as a substitute, in whole or in part, to currently used mineral filler. It can be used in combination with any other mineral fillers known in the industry in various proportions to achieve desired properties.

The hyaloclastite mineral filler in accordance with this invention also can be treated or combined with any surface treatment compounds known in the art to improve certain properties, such as hydrophobicity, antioxidant and the like. Such surface treatment compounds can be selected from inorganic materials such as metal oxides, hydrated lime or organic materials such as any organic functional groups such as carboxyls, lactone, quinone, silanes such as organosilane, organic acids such as steritic, oleic and benzoic acid, alkaline substances, antidegradant compounds, amines such as triethanolamines, glycols, such as diethylene glycol, polyethelyne gycol, phenolics, phosphites, homogenizing agents, flame retardants, or any other type of surface treatment compound currently used in the industry.

Generally, a rubber composition has a formulation containing the following ingredients, one or more rubber types, such as natural or synthetic rubber or combinations thereof, fillers, such as carbon black filler and non-black filler or a combination thereof, process oil, activators, antioxidants, accelerators and vulcanizing agents. Generally, these ingredients are measured in proportions relative to the amount of rubber. The quantity is measured in “phr”, meaning “parts per hundred rubber”. Alternatively, the compositions can also be measured by percentage of weight units.

TABLE 10
General rubber composition:

| Materials | Content (phr) |
|---|---|
| Rubber | 100 |
| Filler | 10-100 |
| Process Oil | 0-10 |
| Activators | 0-10 |
| Antioxidants | 0-10 |
| Accelerators | 0-10 |
| Vulcanization Agents | 6-10 |

### Examples 1-6 of a Rubber Tire are Shown in the Table 11 and Further Described Below:

Rubber used for a vehicle tire is made from a well-known composition and a well-established manufacturing process. However, there are also different types of rubber compounds and formulations used in tire manufacturing depending on the properties desired and the conditions the tire is exposed to.

TABLE 11
Examples of rubber tire tread using hyaloclastite in accordance with the present invention:

| | Amounts (parts by weight) | | | | | |
|---|---|---|---|---|---|---|
| | Example | Example | Example | Example | Example | Example |
| Ingredients | 1 | 2 | 3 | 4 | 5 | 6 |
| Natural Rubber (NR) | 50 | 50 | 50 | 0 | 0 | 0 |
| Polybutadiene Rubber (BR) | 50 | 50 | 50 | 100 | 100 | 100 |
| Carbon black | 5 | 5 | 5 | 5 | 5 | 5 |
| Precipitated Silica | 40 | 25 | 0 | 40 | 25 | 0 |
| Hyaloclastite | 10 | 25 | 50 | 10 | 25 | 50 |
| Silane coupling agent | 5 | 5 | 5 | 5 | 5 | 5 |
| Resin | 10 | 10 | 10 | 10 | 10 | 10 |
| Wax | 1 | 1 | 1 | 1 | 1 | 1 |
| Antioxidant | 2 | 2 | 2 | 2 | 2 | 2 |
| Liquid plasticizer | 30 | 30 | 30 | 30 | 30 | 30 |
| Stereatic acid | 1 | 1 | 1 | 1 | 1 | 1 |
| Zinc oxide | 1.5 | 1.5 | 1.5 | 1.5 | 1.5 | 1.5 |
| Sulfur | 1 | 1 | 1 | 1 | 1 | 1 |
| Vulcanization accelerator | 2 | 2 | 2 | 2 | 2 | 2 |

A pneumatic tire of the present invention can be produced using the rubber composition by usual methods. Specifically, the rubber composition containing the above-mentioned components, before vulcanization, can be extruded into the shape of a tread (e.g., a cap tread) and assembled with other tire components such as reinforcing materials, on a tire building machine in a usual manner known by those skilled in the art to build an unvulcanized tire, which can then be heated and pressurized in a vulcanizer to produce a finished vehicle tire. A tire in accordance with the present invention can be suitably used for any vehicle, especially for passenger vehicles.

The chemicals used in the examples above are listed as follows:
Natural Rubber: RSS #3,
Polybutadiene Rubber (BR): BR150B (cis content: 95% by mass or higher) available from Milagro Rubber Company Austin, TX
Carbon black: Seast N220 available from Cabot Corporation
Precipitated Silica: ZEOSIL P200MP (N2SA: 215 m2/g) available from Rhodia, Hyaloclastite Filler in accordance with the present invention, particle size 4 microns d50
Silane coupling agent: Si-69 available from Evonik Degussa,
Resin: 1: a-methyl styrene resin (Sylvares SA120 available from Kraton Corporation, softening point: 120° C.)
Wax: Ozoace wax available from Key Polymers, Lawrence MA
Antioxidant: 2246 available from Parchem Chemicals, Rochelle NY
Liquid plasticizer: PS-32 (mineral oil) available from Idemitsu Kosan Co., Ltd.
Stearic acid: available from Sage Oil LLC, Las Vegas, NV
Zinc oxide: zinc oxide #2 available from Bisley International, Woodlands, TX
Sulfur: powdered sulfur available from Parchem Chemicals, Rochelle, NY
Vulcanization accelerator: NOCCELER NS available from Ouchi Shinko Chemical Industrial Co., Ltd.

Natural rubber plus silica, or polybutadiene rubber plus silica, natural rubber plus silica and hyaloclastite filler, or polybutadiene rubber plus silica and hyaloclastite filler are added in the amounts listed in Table 11 to a 1.7 L Banbury mixer and kneaded at 150° C. for three minutes to give a kneaded mixture (masterbatch). To the combined masterbatches are added the materials other than the sulfur and vulcanization accelerator, and they are kneaded at 150° C. for two minutes to give a kneaded mixture. The kneaded mixture is further kneaded with the sulfur and vulcanization accelerator using an open roll mill at 80° C. for 45 minutes to obtain an unvulcanized rubber composition.

The unvulcanized rubber compositions prepared as above are vulcanized at 170° C. for 15 minutes to obtain vulcanized rubber compositions (specimens). Separately, the unvulcanized rubber compositions prepared as above are each formed into a cap tread shape and assembled with other tire components, followed by vulcanization at 170° C. for 15 minutes to prepare a test tire. The vulcanized rubber compositions (specimens) and tires prepared as above are stored at room temperature in a dark place for three months and thereafter evaluated for performance.

### Examples 7-12 of an EPDM Rubber Compound are Shown in the Table 12 and Further Described Below:

EPDM rubber compositions are known in the industry. The hyaloclastite mineral filler in accordance with the present inventions can be used as a filler to improve properties of EPMD rubber materials.

In one example, the following materials are used natural rubber types of RSS-1 and ethylene propylene diene monomer (Bayer M Ltd/THEP130865W) specification as follows ethylene 67%; ENB 43%; density 1.3 g/cm³; hardness 65±5 Shore A; compression set 40% fillers. plasticizers/lubricants/peptiser: paraffinic oil, brown factice, stearic acid, paraffin wax (Oleo-chemicals Industry, PT Sumi Asih). Activators: ZnO (NC 105 Global Chemical Co, Ltd). Other chemicals as follow CBS n-cyclohexyl-2-benzothiazyl sulphenamide; DPG iphenyl guanidine, and sulfur curative agent (Brataco Chemical). The vulcanizate is compounded based on the formulation as follows: 40 phr of EPDM; 60 phr of natural rubber type: ribbed smoke sheet (RSS-1); 2 phr of paraffinic oil, 2 phr of brown factice, 4 phr of zinc oxide; 1.5 of stearic acid; 0.5 of paraffin wax; 1.5 phr of CBS; 0.5 phr of DPG; 2.5 phr of sulphur. The total amount of filler is varied 50; 60; and 70 phr for rubber compounding. Meanwhile, the hyaloclastite mineral filler is of basaltic chemistry with a volume-based mean particle size of 12 microns (D50). Polymer, filler and other chemicals are compounded using a laboratory mill based on the standard procedure of ASTM D3182. The preparation of vulcanized sheets is done using the ASTM D3184-89 procedure. In order to examine the tensile properties, the compounded rubber sheet is vulcanized for 90 minutes at 150° C. using a heating hydraulic press. The finished vulcanized sheet has improved physical properties compared to a commercially available EPDM sheet.

Polymeric EPDM rubber materials using a mineral filler in powder form made from hyaloclastite mineral filler powder in accordance with the present invention have enhanced properties such as improved friability, rigidity, hardness, fire resistance, flame spread and thermal properties. Hyaloclastite mineral filler powder contributes to a decrease of the heat release rate, thereby showing improved thermal stability, flame spread and fire resistance of the EPDM polymeric rubber materials using this type of mineral filler. Polymeric EPDM rubber materials using the hyaloclastite mineral filler powder also show self-extinguishing properties.

TABLE 12
Examples of EPDM rubber compositions for hose and automotive applications

| | Amounts (parts by mass) | | | | | |
|---|---|---|---|---|---|---|
| | Example | Example | Example | Example | Example | Example |
| Ingredients | 7 | 8 | 9 | 10 | 11 | 12 |
| EPDM (High ENB) | 60 | 60 | 40 | 40 | 100 | 100 |
| EPDM (High | 40 | 40 | 60 | 60 | 0 | 0 |
| Ethylene) | | | | | | |
| Carbon black | 40 | 25 | 60 | 25 | 70 | 40 |
| Silica | 35 | 25 | 15 | 25 | 0 | 0 |
| Hyloclastite filler | 0 | 25 | 0 | 25 | 0 | 35 |
| N′-isopropyl-N- | 1 | 1 | 1 | 1 | 1 | 1 |
| phenyl-phenylene | | | | | | |
| diamine | | | | | | |
| Parrafin Oil | 2.5 | 2.5 | 2.5 | 2.5 | 2.5 | 2.5 |
| Sulfur | 1 | 1 | 1 | 1 | 1 | 1 |
| Zinc oxide | 3 | 3 | 3 | 3 | 3 | 3 |
| Stereatic acid | 1 | 1 | 1 | 1 | 1 | 1 |
| CZ | 1 | 1 | 1 | 1 | 1 | 1 |

An aspect of the present invention applies to a rubber composition for preventing galvanic corrosion. The rubber composition includes a base polymer, a reinforcing agent, an anti-aging agent, an activating agent, a plasticizer and a crosslinking agent. The base polymer includes a first ethylene propylene diene monomer (EPDM) rubber and a second EPDM rubber. The first EPDM rubber is EPDM including 8% to 10% of 5-ethylidene-2-norbornene (ENB). The second EPDM rubber is EPDM includes 70% to 75% of ethylene. The weight ratio of the first EPDM rubber and the second EPDM rubber is 30 to 50:50 to 70. In an aspect of the present disclosure, the rubber composition has electrical insulation resistance (107 Ω·cm) of 50 or more. In a disclosed embodiment of the present invention, the EPDM rubber is an ethylene-propylene-diene terpolymer. The diene includes one selected from the group comprising or consisting of ENB, dicyclopentadiene (DCPD), 1,4-pentadiene, cyclohexadiene and cyclic or bridged diene. In another disclosed embodiment of the present invention, EPDM having high heat resistance and weather resistance is used by blending EPDM having high ENB content (8 to 10%) with EPDM having high ethylene content (70 to 75%). EPDM having high ENB content can increase softness because of the increased ENB content. Thus, the EPDM can exhibit good processability and can be favorably applied to extruded products, but can deteriorate properties such as scorch stability, elongation, thermal aging, and the like. On the other hand, EPDM having high ethylene content can ensure desirable mechanical properties and can thus exhibit durability, such as burst pressure required of hoses. However, when added in excess, increased crystallinity and thus poor processability can result. In order to ensure these advantages at the same time, two kinds of EPDM are blended, and can thus be optimally compounded. In some cases, the first EPDM rubber and the second EPDM rubber are used at a weight ratio of 30 to 50:50 to 70, thereby ensuring both of the above advantages at the same time. In another aspect of the present invention, the reinforcing agent includes carbon black and an inorganic filler. Based on 100 parts by weight of the base polymer, the amount of the carbon black is 25 to 70 parts by weight, the amount of the precipitated silica filler is 0 to 45 parts by weight and the amount of the hyaloclastite filler is 0 to 45 parts by weight. In an aspect of the present disclosure, the carbon black has dibutyl phthalate (DBP) absorption (m/100 g) of 40 to 150 and 12 (mg/g) of 10 to 50. In an aspect of the present invention, the inorganic filler is silica. The silica has Brunauer, Emmett, and Teller (BET) surface area (m²/g) of 180 to 230 and a density (g/1) of 120 to 160. The hyaloclastite filler has a volume-based mean particle size of 6 micron. In a disclosed embodiment of the present invention, in the case of the reinforcing agent, an inorganic filler (silica and/or hyaloclastite) can be used as a base in order to ensure the electrical insulation properties required of the above material. Moreover, carbon black can be blended in order to ensure fatigue resistance and robustness against permanent deformation, which are typically required of hoses. The reinforcing agent can be used in an optimal blending amount because dispersibility in a rubber phase is very useful from the viewpoint of durability. Superior durability can be obtained when the carbon black is used in an amount of 30 to 50 parts by weight and the inorganic filler is used in an amount of 25 to 45 parts by weight based on 100 parts by weight of the base polymer. In a disclosed embodiment of the present invention, the amount of the anti-aging agent is 0.5 to 1.5 parts by weight based on 100 parts by weight of the base polymer. The anti-aging agent is N′-isopropyl-N-phenyl-phenylene diamine. In a disclosed embodiment of the present invention, the amount of the activating agent is 1.5 to 6 parts by weight based on 100 parts by weight of the base polymer. The activating agent is at least one of zinc oxide and stearic acid. In a disclosed embodiment of the present invention, the activating agent includes zinc oxide and stearic acid. The amount of zinc oxide is 2 to 4 parts by weight based on 100 parts by weight of the base polymer. The amount of stearic acid is 0.5 to 1.5 parts by weight based on 100 parts by weight of the base polymer. In a disclosed embodiment of the present invention, the amount of the plasticizer is 1.5 to 3.5 parts by weight based on 100 parts by weight of the base polymer. The plasticizer is paraffin oil. In a disclosed embodiment of the present invention, when the inorganic filler is added in excess relative to the amount of carbon black, the Mooney viscosity of the resulting compound can be greatly increased (hardened). Hence, the amount of the plasticizer is adjusted for optimal compounding, thereby attaining desired product extrudability. In some cases, the amount of the plasticizer is 1 to 5 parts by weight based on 100 parts by weight of the base polymer. Given the above range, desired product extrudability can be attained. In a disclosed embodiment of the present invention, the amount of the crosslinking agent is 0.5 to 3.5 parts by weight based on 100 parts by weight of the base polymer. The crosslinking agent is sulfur.

Another aspect of the present invention pertains to a method of preparing the rubber composition. The method includes mixing a base polymer with a reinforcing agent comprising hyaloclastite filler, an anti-aging agent, an activating agent, and a plasticizer and mixing the mixed polymer with a crosslinking agent. In a disclosed embodiment of the present invention, the base polymer includes a first EPDM rubber and a second EPDM rubber. The first EPDM rubber is EPDM including 8% to 10% of ENB. The second EPDM rubber is EPDM including 70% to 75% of ethylene. The weight ratio of the first EPDM rubber and the second EPDM rubber is 30 to 50:50 to 70. In another disclosed embodiment of the present invention, the reinforcing agent includes carbon black and an inorganic filler comprising a hyaloclastite filler. Based on 100 parts by weight of the base polymer, the amount of the carbon black is 30 to 50 parts by weight and the amount of the inorganic filler is 5 to 45 parts by weight.

In order to prepare engine mount and hose compositions having improved heat resistance and fatigue resistance, components are compounded in the amounts shown in the following Table 13 to thus manufacture specimens. EPDM is masticated for 3 min using a kneader, mixed together with a reinforcing agent, an anti-aging agent, a processing adjuvant, and a plasticizer, kneaded for 3 to 4 min, and cleaned for 1 to 2 min, thus obtaining a final carbon master batch (CMB) compound. The CMB compound is mixed with a crosslinking agent using a roll mixer. The rubber composition thus obtained is measured for appropriate vulcanization time using a rheometer and is then heated and pressed at 160 kgf/cm^{z} using a hot press, thereby manufacturing vulcanized specimens. After proper cure the rubber specimens and products are tested and evaluated for the following properties: hardness, tensile strength and elongation, electrical insulation resistance and product-bursting strength and thermal stability:

Rubber specimens using hyaloclastite filler show improved properties, especially increased thermal stability, when compared with specimens using only carbon black or carbon black and precipitated silica.

### Examples 13-18 of Rubber for a Conveyer Belt are Shown in the Table 13 and Further Described Below:

TABLE 13
Examples of rubber compositions for a conveyor belt:

| | Amounts (parts by mass) | | | | | |
|---|---|---|---|---|---|---|
| | Example | Example | Example | Example | Example | Example |
| Ingredients | 13 | 14 | 15 | 16 | 17 | 18 |
| Natural Rubber (NR) | 40 | 40 | 40 | 40 | 40 | 40 |
| Styrene/Butadiene | 60 | 60 | 60 | 60 | 60 | 60 |
| Rubber (SBR) | | | | | | |
| Carbon black | 60 | 40 | 30 | 60 | 40 | 30 |
| Hyaloclastite filler | | 20 | 30 | | 20 | 30 |
| Silane coupling agent | | 2 | 3 | | 2 | 3 |
| Phenolic Resin | 3 | 3 | 3 | 3 | 3 | 3 |
| Aromatic Oil | 5 | 5 | 5 | 5 | 5 | 5 |
| Sulfur | 3 | 3 | 3 | 3 | 3 | 3 |
| Zinc oxide | 15 | 15 | 15 | 15 | 15 | 15 |
| Stereatic acid | 1 | 1 | 1 | | | |
| Zinc dimethacrylate | 2 | 2 | 2 | 2 | 2 | 2 |
| Cobalt Stearate | 6 | 6 | 6 | | | |
| Vulcanization | 1 | 1 | 1 | 1 | 1 | 1 |
| accelerator | | | | | | |

The rubber component can be formed from the natural rubber and the synthetic rubber in any ratio without specific restrictions. The amount of the natural rubber is usually 20 to 70 parts by weight and preferably 20 to 50 parts by weight, and the amount of the synthetic rubber is usually 80 to 30 parts by weight and preferably 80 to 50 parts by weight, with their total amount being 100 parts by weight.

The components shown in Table 13 are commercially available from industry suppliers:
Natural rubber: RSS #3
Styrene-butadiene rubber: SBR 1500
Carbon black: Seast N220 available from Cabot Corporation “#70”
Basaltic Hyaloclastite filler: mean particle size 12 micron, Greencraft LLC, Norcross, GA
Silane Coupling agent: Si-69 available from Evonik Degussa
Phenolic Resin-I: Sumitomo Bakelite Co., Ltd., “Sumilite Resin PR-50235
Aromatic oil: Idemitsu Kosan Co., Ltd., “Diana Process OiIAH-85”
Sulfur: powdered sulfur available from Parchem Chemicals, Rochelle, NY
Zinc oxide: zinc oxide #2 available from Bisley International, Woodlands, TX
Stearic acid: available from Sage Oil LLC, Las Vegas, NV
Zinc dimethacrylate: Kawaguchi Chemical Industry Co., Ltd., “Actor ZMA”
Cobalt stearate: DIC Corporation, “Cobalt Stearate”
Vulcanization accelerator: Ouchi Shinko Chemical Industrial Co., Ltd., “Nocceler NS-F”

The rubber composition for each of the foregoing Examples 14-19 is prepared by kneading the components shown in Table 13 all at once in a Banbury mixer. The resulting rubber composition is made into a sheet (15 mm thick). The sheets are placed one over the other, with a galvanized steel cord (7 mm in diameter) held between them, and the resulting assembly is heated under pressure for vulcanization at 170° C. for 40 minutes. Specimens from each composition are cured and tested for performance such as initial adhesion strength, adhesion strength after heat aging, adhesion strength after moisture absorption, rate of vulcanization, rolling performance and laminating performance.

Specimens using hyaloclastite show superior performance when compared to specimens that do not use hyaloclastite.

Any other type of rubber compound can be similarly configured to use hyaloclastite as a mineral filler to replace one or more of currently used mineral fillers, in whole or in part.

Polymeric rubber or natural rubber materials using a mineral filler in powder form made from hyaloclastite or lava quenched by water in accordance with the present invention have enhanced properties such as improved friability, rigidity, hardness, fire resistance, flame spread and thermal properties. Physical properties such as compressive, flexural and tensile strength are improved by the use of such fillers in polyurethane foams or rigid products. Hyaloclastite or lava quenched by water mineral filler in accordance with the present invention contributes to the decrease of the heat release rate, thereby showing improved thermal stability, flame spread and fire resistance of the rubber materials using this type mineral filler. Polymeric rubber or natural rubber materials using hyaloclastite, or lava quenched by water, mineral filler in accordance with the present invention also show self-extinguishing properties.

Hyaloclastite, or lava quenched by water, fillers of basaltic or intermediate-basaltic chemistry in accordance with the present invention can be also used as fillers in polymeric rubber compounds including, but not limited to, Buna rubbers, such as styrene butadiene rubber (SBR), poly-butadiene rubber (BR); butyl rubbers, and neoprene. Other specific types of synthetic or polymeric rubbers include, but are not limited to, acrylonitrile butadiene rubber (NBR) polyisobutylene, polyisoprene, chloroprene, nitrile rubber, chlorosulphonated polyethylene, silicone rubber, ethylene propylene rubber (EPR), and polysulfide rubbers (thiokols).

Products made from synthetic rubber which can include hyaloclastite, or lava quenched by water, fillers of basaltic or intermediate-basaltic chemistry in accordance with the present invention include, but are not limited to tires, door and window profiles, seals such as O-rings and gaskets, hoses, belts, membranes, matting, flooring, clothing, shoe soles, fibers, fabrics, clutches, engine bearings, conveyor belts, molded rubber products, electrical insulation, gloves, coating, sealants, expanded rubber such as sponges and mattresses, and numerous other products.

U.S. Pat. No. 11,884,602 is incorporated herein by reference in its entirety. It is specifically contemplated that hyaloclastite, or lava, quenched by water, of basaltic or intermediate basaltic chemistry and having carbon dioxide sequestered or mineralized; i.e., absorbed or adsorbed into/on to the micro and nano-cavities, or on its rough surface, and reacting or potentially reacting with the un-carbonated elements contained therein, such as Ca, Mg, Na, K, Fe, K to form simple or complex carbonate minerals, in accordance with the process disclosed in U.S. Pat. No. 11,884,602 can be used as a filler or additive for natural rubber or synthetic rubber in accordance with the invention disclosed herein.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A composition comprising an uncured rubber material blended with hyaloclastite having a volume-based mean particle size of less than or equal to 160 μm.

2. The composition of claim 1, wherein the hyaloclastite is basaltic hyaloclastite or intermediate basaltic hyaloclastite.

3. The composition of claim 2, wherein the basaltic hyaloclastite or intermediate basaltic hyaloclastite has a volume-based mean particle size of less than or equal to 100 μm.

4. The composition of claim 2, wherein the basaltic hyaloclastite or intermediate basaltic hyaloclastite has a volume-based mean particle size of less than or equal to 40 μm.

5. The composition of claim 2, wherein the basaltic hyaloclastite or intermediate basaltic hyaloclastite has a volume-based mean particle size of less than or equal to 20 μm.

6. The composition of claim 1, wherein the rubber material is a natural rubber material.

7. The composition of claim 1, wherein the rubber material is a synthetic rubber material.

8. The composition of claim 7, wherein the synthetic rubber material is butadiene rubber (BR), styrene-butadiene rubber (SBR), butyl rubber (IIR), nitrile rubber (NBR), neoprene/polychloroprene rubber (CR), ethylene propylene diene monomer rubber (EPDM), ethylene propylene rubber (EPR), silicone rubber (Q), fluoroeleastomer/viton rubber (FKM), polyurethane rubber (AU), hydrogenated nitrile rubber (HNBR), acrylic rubber (ACM), chlorosulfonated polyethylene rubber (CSM), polyisoprene rubber (IR), fluoroelastomers (FKM) perfluoroelastomer rubber (FFKM), polysulfide (thiokol) rubber (PSR), acrylonitrile butadiene rubber (NBR) or polyisobutylene rubber.

9. The composition of claim 1, wherein the hyaloclastite comprises approximately 0.1% to approximately 20% by weight relative to rubber material.

10. A composition comprising an uncured natural rubber material or synthetic rubber material blended with basaltic hyaloclastite or intermediate basaltic hyaloclastite having a volume-based mean particle size of less than or equal to 160 μm.

11. The composition of claim 10, wherein the basaltic hyaloclastite or intermediate basaltic hyaloclastite has a volume-based mean particle size of less than or equal to 100 μm.

12. The composition of claim 10, wherein the basaltic hyaloclastite or intermediate basaltic hyaloclastite has a volume-based mean particle size of less than or equal to 40 μm.

13. The composition of claim 10, wherein the basaltic hyaloclastite or intermediate basaltic hyaloclastite has a volume-based mean particle size of less than or equal to 20 μm.

14. The composition of claim 10, wherein the synthetic rubber material is butadiene rubber (BR), styrene-butadiene rubber (SBR), butyl rubber (IIR), nitrile rubber (NBR), neoprene/polychloroprene rubber (CR), ethylene propylene diene monomer rubber (EPDM), ethylene propylene rubber (EPR), silicone rubber (Q), fluoroeleastomer/viton rubber (FKM), polyurethane rubber (AU), hydrogenated nitrile rubber (HNBR), acrylic rubber (ACM), chlorosulfonated polyethylene rubber (CSM), polyisoprene rubber (IR), fluoroelastomers (FKM) perfluoroelastomer rubber (FFKM), polysulfide (thiokol) rubber (PSR), acrylonitrile butadiene rubber (NBR) or polyisobutylene rubber.

15. A process comprising combining hyaloclastite with an uncured natural rubber material or synthetic rubber material, wherein the hyaloclastite has a volume-based mean particle size of less than or equal to 160 μm.

16. The process of claim 15, wherein the hyaloclastite is basaltic hyaloclastite or intermediate basaltic hyaloclastite.

17. The process of claim 16, wherein the basaltic hyaloclastite or intermediate basaltic hyaloclastite has a volume-based mean particle size of less than or equal to 40 μm.

18. The process of claim 15, wherein the synthetic rubber material is butadiene rubber (BR), styrene-butadiene rubber (SBR), butyl rubber (IIR), nitrile rubber (NBR), neoprene/polychloroprene rubber (CR), ethylene propylene diene monomer rubber (EPDM), ethylene propylene rubber (EPR), silicone rubber (Q), fluoroeleastomer/viton rubber (FKM), polyurethane rubber (AU), hydrogenated nitrile rubber (HNBR), acrylic rubber (ACM), chlorosulfonated polyethylene rubber (CSM), polyisoprene rubber (IR), fluoroelastomers (FKM) perfluoroelastomer rubber (FFKM), polysulfide (thiokol) rubber (PSR), acrylonitrile butadiene rubber (NBR) or polyisobutylene rubber.

19. An article made by the process of claim 18.

20. A tire made by the process of claim 18.
